(19) United States
(12) Patent Application Publication
(10) Pub. No.: US 2022/0210484 A1
(43) Pub. Date: Jun. 30, 2022

(54) METHOD FOR PROCESSING LIVE BROADCAST DATA, SYSTEM, ELECTRONIC DEVICE, AND STORAGE MEDIUM

(71) Applicant: GUANGZHOU HUYA TECHNOLOGY CO., LTD., Guangzhou (CN)

(72) Inventors: Jing YOU, Guangzhou (CN); Zhiwei TANG, Guangzhou (CN)

(21) Appl. No.: 17/566,790

(22) Filed: Dec. 31, 2021

Related U.S. Application Data
(63) Continuation-in-part of application No. PCT/CN2020/099053, filed on Jun. 29, 2020.

(30) Foreign Application Priority Data
Jul. 4, 2019 (CN) 201910599248.7
Jul. 31, 2019 (CN) 201910700981.3
Aug. 1, 2019 (CN) 201910708018.X

(51) Int. Cl. H04N 21/2187; A63F 13/86; A63F 13/35

(52) U.S. Cl. CPC H04N 21/2187; A63F 2300/308; A63F 13/35; A63F 13/86

(57) ABSTRACT

A method for processing live broadcast data, a system, an electronic device, and a storage medium, relating to the technical field of Internet live broadcast. A live broadcast providing terminal sends to a server a data execution instruction and graphical interaction data corresponding to the data execution instruction, such that the server performs processing on the graphical interaction data in response to the data execution instruction, and delivers an obtained graphical interaction scene. In this way, by configuring a graphical interaction data processing procedure on a server side of a live broadcast system, the data processing amount of the live broadcast providing terminal can be reduced, thereby reducing hardware overheads of the live broadcast providing terminal and improving a live broadcast effect.

### CROSS-REFERENCE TO RELATED APPLICATIONS

The present disclosure claims priority to Chinese Patent Application No. 201910708018X, entitled “Live Broadcast Data Processing Method and Apparatus, Electronic Device, and Readable Storage Medium” and filed with the China National Intellectual Property Administration on Aug. 1, 2019, Chinese Patent Application No. 2019107009813 and entitled “Cloud Rendering Method and Apparatus, Terminal Device and Readable Storage Medium” and filed with the China National Intellectual Property Administration on Jul. 31, 2019, and Chinese Patent Application No. 2019105992487 and entitled “Remote Rendering Method and Apparatus, Electronic Device and Readable Storage Medium” and filed with the China National Intellectual Property Administration on Jul. 4, 2019, the entire contents of which are incorporated herein by reference.

### TECHNICAL FIELD

The present disclosure relates to the field of Internet live broadcast technology, and specifically provides a live broadcast data processing method (i.e., a method for processing live broadcast data) and system, an electronic device, and a storage medium.

### BACKGROUND ART

In some scenarios such as game live broadcast, generally an MC (microphone controller) runs a live game and also runs a game screenshot application or the like to continuously get screenshots of the game, a live video stream is thus generated continuously according to the screenshots of the game and sent to a server, and then the server forwards the live video stream to viewer clients, so that the live game content can be completely presented to the viewer clients.

For example, in the above-mentioned live broadcast scenario, hardware resource overhead for live broadcast data processing is generally on a live broadcast provider terminal on the MC side; however, as the volume of data involved in live video increases, the hardware overhead for processing live broadcast data is also increasing. The hardware performance of the live broadcast provider terminal may cause the live broadcast effect of a live broadcast system to be poor.

### SUMMARY

Provided is a live broadcast data processing method, applied to a server, the method including:

obtaining game resources of a live game obtained by a live broadcast provider terminal (a live broadcast terminal) after the live game is run, the game resources being obtained by the live broadcast provider terminal by calling interface parameters of an application programming interface corresponding to the game resources in the live game;

adjusting the game resources according to a setting rule and generating corresponding live broadcast cache data according to the adjusted game resources; and

sending the live broadcast cache data to a live broadcast receiver terminal for playback.

Provided is a live broadcast data processing method, applied to a live broadcast provider terminal, the method including:

after a live game is run, calling interface parameters of an application programming interface corresponding to game resources in the live game to obtain the game resources of the live game; and

sending the game resources to a server so that, after receiving the game resources, the server adjusts the game resources according to a setting rule, generates corresponding live broadcast cache data according to the adjusted game resources and then sends the live broadcast cache data to the live broadcast receiver terminal for playback.

Provided is a live broadcast data processing method, applied to a live broadcast system, the live broadcast system including a server, as well as a live broadcast provider terminal and a live broadcast receiver terminal that are in communication connection with the server, the method including:

after a live game is run, calling, by the live broadcast provider terminal, interface parameters of an application programming interface corresponding to game resources in the live game to obtain the game resources of the live game, and sending the game resources to the server;

after the server receives the game resources, adjusting the game resources according to a setting rule and generating corresponding live broadcast cache data according to the adjusted game resources; and

sending the live broadcast cache data to the live broadcast receiver terminal for playback.

Provided is a cloud rendering method, applied to a cloud rendering system including a terminal device and a server, the method including:

storing in a lock-free queue, by the terminal device, drawing instructions configured to render a picture (image) and drawing parameters corresponding to the drawing instructions, wherein multiple drawing instructions are required to render one picture;

when detecting that a preset information sending condition is met, sending to the server the drawing instructions and drawing parameters stored in the lock-free queue;

after receiving the drawing instructions and the drawing parameters, performing picture rendering by the server according to the drawing instructions and the drawing parameters;

after finishing the picture rendering, encoding, by the server, the rendered picture and sending the encoded picture to the terminal device; and

after receiving the encoded picture, decoding, by the terminal device, the received picture and displaying the decoded picture.

Provided is a cloud rendering method, applied to a terminal device communicating with a server in a cloud rendering system, the method including:

storing in a lock-free queue drawing instructions configured to render a picture and drawing parameters corresponding to the drawing instructions, wherein multiple drawing instructions are required to render one picture;

when detecting that a preset information sending condition is met, sending to the server the drawing instructions and drawing parameters stored in the lock-free queue; performing picture rendering by the server according to the received drawing instructions and drawing parameters; after finishing the picture rendering, encoding the rendered picture and sending the encoded picture to the terminal device; and

receiving the encoded picture, decoding the received picture, and displaying the decoded picture.

Provided is a remote rendering method, applied to an electronic device installed with a game client, the electronic device being in communication connection with a game server, the method including:

intercepting a graphics API instruction sequence initiated by the game client based on a control instruction input by a user, the graphics API instruction sequence including calling instructions, calling parameters, and a calling order at the game client to graphics API; and

sending the intercepted graphics API instruction sequence to the game server according to an interception order so that a GPU of the game server executes the graphics API instruction sequence to obtain a rendered game picture.

Provided is a live broadcast data processing method, applied to a live broadcast system, the live broadcast system including a live broadcast provider terminal and a server that communicate with each other, the method including:

sending to the server, by the live broadcast provider terminal, a data execution instruction and graphic interaction data corresponding to the data execution instruction; and

in response to the data execution instruction, processing, by the server, the graphic interaction data and sending out an obtained graphic interaction picture.

Provided is a live broadcast data processing method, applied to a live broadcast provider terminal in a live broadcast system, the live broadcast system further including a server that establishes communication with the live broadcast provider terminal, the method including:

sending a data execution instruction and graphic interaction data corresponding to the data execution instruction to the server so that the server processes the graphic interaction data in response to the data execution instruction and sends out an obtained graphic interaction picture.

Provided is a live broadcast data processing method, applied to a server in a live broadcast system, the live broadcast system further includes a live broadcast provider terminal that establishes communication with the server, the method including:

receiving a data execution instruction sent by the live broadcast provider terminal and graphic interaction data corresponding to the data execution instruction; and

in response to the data execution instruction, processing the graphic interaction data and sending out an obtained graphic interaction picture.

Provided is a live broadcast system, including a live broadcast provider terminal and a server that communicate with each other;

the live broadcast provider terminal being configured to send a data execution instruction and graphic interaction data corresponding to the data execution instruction to the server; and

the server being configured to, in response to the data execution instruction, process the graphic interaction data and send out a obtained graphic interaction picture.

Provided is an electronic device, including a memory, a processor, and machine-executable instructions stored in the memory and executed in the processor, the machine-executable instructions implementing, when executed by the processor, the above-mentioned live broadcast data processing method, cloud rendering method, or remote rendering method.

Provided is a readable storage medium, having machine-executable instructions stored thereon, the machine-executable instructions implementing, when executed, the above-mentioned live broadcast data processing method, cloud rendering method, or remote rendering method.

### BRIEF DESCRIPTION OF DRAWINGS

FIG. 1 shows a schematic diagram of an interaction scenario of a live broadcast system according to various embodiments of the present disclosure.

FIG. 2 shows a schematic flowchart of a live broadcast data processing method according to various embodiments of the present disclosure.

FIG. 3 shows a schematic flowchart in a game live broadcast scenario.

FIG. 4 shows another schematic flowchart in a game live broadcast scenario.

FIG. 5 shows a schematic flowchart in a rendering scenario.

FIG. 6 shows a schematic block diagram of a communication relationship between an electronic device and internal modules of a server.

FIG. 7 shows a schematic flowchart in a cloud game scenario.

FIG. 8 shows another schematic flowchart in a cloud game scenario.

FIG. 9 shows yet another schematic flowchart in a cloud game scenario.

FIG. 10 shows a schematic structural block diagram of an electronic device according to various embodiments of the present disclosure.

### DETAILED DESCRIPTION OF EMBODIMENTS

For clear description of the objectives, technical solutions, and advantages of embodiments of the present disclosure, the technical solutions in the embodiments of the present disclosure will be described clearly and completely below in conjunction with the drawings in the embodiments of the present disclosure. It should be understood that the drawings in the present disclosure are only for the purpose of illustration and description, and are not used to limit the protection scope of the present disclosure. In addition, it should be understood that the schematic drawings are not drawn to scale. The flowcharts used in the present disclosure show operations implemented according to some of the embodiments of the present disclosure. It should be understood that the operations of the flowchart may be implemented out of order, and steps without logical context relationship may be implemented in reverse order or at the same time. In addition, under the guidance of the content of the present disclosure, those skilled in the art can add one or more other operations to the flowchart, or remove one or more operations from the flowchart.

In addition, the described embodiments are only a part of the embodiments of the present disclosure, rather than all the embodiments. The components in embodiments of the present disclosure, typically described and illustrated herein in the drawings, may be arranged and designed in a variety of different configurations. Accordingly, the following detailed description of the embodiments of the present disclosure provided in the drawings is not intended to limit the scope of the present disclosure claimed, but merely to explain part of embodiments of the present disclosure. All other embodiments obtained by a person of skill in the art based on the embodiments of the present disclosure without creative efforts shall fall within the protection scope of the present disclosure.

Objectives of the present disclosure include, for example, providing a live broadcast (live streaming) data processing method and system, an electronic device, and a storage medium, which can provide a live broadcast effect.

The embodiments of the present disclosure provide a live broadcast data processing method, applicable to a server, the method comprising following steps:

obtaining game resources of a live game obtained by a live broadcast provider terminal after the live game is run, the game resources being obtained by the live broadcast provider terminal by calling interface parameters of an application programming interface corresponding to the game resources in the live game;

adjusting the game resources according to a setting rule and generating corresponding live broadcast cache data according to an adjusted game resources; and

sending the live broadcast cache data to a live broadcast receiver terminal for playback.

In various embodiments, the setting rule includes preset viewing angle customization information; and

the step of adjusting the game resources according to a setting rule includes:

calling an interface instruction sequence and interface resources of a graphics application programming interface corresponding to the live game and adjusting a camera viewing angle in the game resources to a preset viewing angle in the preset viewing angle customization information; and

adjusting the game resources based on the preset viewing angle to generate the adjusted game resources.

In various embodiments, the setting rule further includes game texture replacement information, and the game texture replacement information includes identification information of at least one to-be-replaced first game texture image and a second game texture image configured to replace each first game texture image; and

the step of adjusting the game resources according to a setting rule includes:

calling an interface instruction sequence and interface resources of a graphics application programming interface corresponding to the live game, and obtaining each to-be-replaced first game texture image from the game resources according to identification information of each first game texture image; and

replacing each to-be-replaced first game texture image with a corresponding second game texture image to generate the adjusted game resources.

In various embodiments, the setting rule includes game audio customization information, and the game audio customization information includes identification information of at least one to-be-replaced first game audio and a second game audio configured to replace each first game audio; and

the step of adjusting the game resources according to a setting rule includes:

calling an interface instruction sequence and interface resources of an audio application programming interface corresponding to the live game, and obtaining each to-be-replaced first game audio from the game resources according to identification information of each first game audio; and

replacing each to-be-replaced first game audio with a corresponding second game audio to generate the adjusted game resources.

The embodiments of the present application provide a live broadcast data processing method, applicable to a live broadcast provider terminal, the method comprising following steps:

calling, after a live game is run, interface parameters of an application programming interface corresponding to game resources in the live game to obtain the game resources of the live game; and

sending the game resources to a server so that, after receiving the game resources, the server adjusts the game resources according to a setting rule, generates corresponding live broadcast cache data according to adjusted game resources and then sends the live broadcast cache data to a live broadcast receiver terminal for playback.

In various embodiments, the step of calling, after a live game is run, interface parameters of an application programming interface corresponding to game resources in the live game to obtain the game resources of the live game includes:

running a preset dynamic link library file in a running process of the live game after the live game is run, wherein the preset dynamic link library file includes a running program configured to intercept the interface parameters of the application programming interface of the live game, and the application programming interface includes a graphics application programming interface and/or an audio application programming interface; and

obtaining the interface parameters of the application programming interface of the live game through the preset dynamic link library file and obtaining the game resources of the live game according to the interface parameters, wherein the game resources includes game graphics resources and game audio resources.

The embodiments of the present application provide a live broadcast data processing method, applicable to a live broadcast system, the live broadcast system comprising a server, as well as a live broadcast provider terminal and a live broadcast receiver terminal that are in communication connection with the server, the method comprising:

calling, after a live game is run, by the live broadcast provider terminal, interface parameters of an application programming interface corresponding to game resources in the live game to obtain the game resources of the live game, and sending the game resources to the server;

adjusting, after receiving the game resources, by the server, the game resources according to a setting rule and generating corresponding live broadcast cache data according to adjusted game resources; and

sending the live broadcast cache data to the live broadcast receiver terminal for playback.

The embodiments of the present application provide a cloud rendering method, applicable to a cloud rendering system comprising a terminal device and a server, the method comprising following steps:

storing in a lock-free queue, by the terminal device, drawing instructions configured to render a picture and drawing parameters corresponding to the drawing instructions, wherein multiple drawing instructions are required to render one picture;

sending to the server the drawing instructions and the drawing parameters stored in the lock-free queue when detecting that a preset information sending condition is met;

performing picture rendering by the server according to the drawing instructions and the drawing parameters after receiving the drawing instructions and the drawing parameters;

encoding, by the server, a rendered picture and sending an encoded picture to the terminal device after finishing the picture rendering; and

decoding, by the terminal device, a received picture and displaying a decoded picture after receiving the encoded picture.

In various embodiments, the step of decoding, by the terminal device, a received picture and displaying a decoded picture after receiving the encoded picture includes:

using an independent IO receiving thread to receive the encoded picture; and

decoding the encoded picture by means of hardware acceleration and displaying the decoded picture.

In various embodiments, the step of performing picture rendering by the server according to the drawing instructions and the drawing parameters after receiving the drawing instructions and the drawing parameters includes:

disabling a vertical synchronization function of the server, deserializing data sent by the terminal device to obtain the drawing instructions and the drawing parameters, and performing picture rendering according to the drawing instructions and the drawing parameters.

In various embodiments, the step of encoding, by the server, a rendered picture and sending an encoded picture to the terminal device after finishing the picture rendering includes:

obtaining the rendered picture from a front-end buffer area of a graphics card of the server; and

encoding the rendered picture by means of hardware acceleration, serializing the encoded picture and storing, in a send queue, data obtained after serialization; and sending the data stored in the send queue to the terminal device according to a network status between the server and the terminal device.

The embodiments of the present application provide a cloud rendering method, applicable to a terminal device communicating with a server in a cloud rendering system, the method comprising following steps:

storing in a lock-free queue drawing instructions configured to render a picture and drawing parameters corresponding to the drawing instructions, wherein multiple drawing instructions are required to render one picture;

sending, when detecting that a preset information sending condition is met, to the server the drawing instructions and the drawing parameters stored in the lock-free queue; performing picture rendering by the server according to received drawing instructions and drawing parameters; encoding a rendered picture and sending a encoded picture to the terminal device after finishing the picture rendering; and

receiving the encoded picture, decoding a received picture, and displaying a decoded picture.

The embodiments of the present application provide a remote rendering method, applicable to an electronic device installed with a game client, the electronic device being in communication connection with a game server, the method comprising following steps:

intercepting a graphics API instruction sequence initiated by the game client based on a control instruction input by a user, wherein the graphics API instruction sequence includes calling instructions, calling parameters and a calling order at the game client to graphics APIs; and

sending an intercepted graphics API instruction sequence to the game server according to an interception order so that a GPU of the game server executes the graphics API instruction sequence to obtain a rendered game picture.

In various embodiments, the step of intercepting a graphics API instruction sequence initiated by the game client based on a control instruction input by a user includes following steps:

encapsulating each intercepted graphics API instruction sequence into a task, and adding encapsulated tasks to a work queue according to the interception order; and executing the tasks in the work queue sequentially through independent network IO thread and sending the graphics API instruction sequence in each task to the game server.

In various embodiments, the step of executing the tasks in the work queue sequentially through independent network IO thread and sending the graphics API instruction sequence in each task to the game server includes:

processing the graphics API instruction sequence in each task in sequence into a to-be-sent data packet and buffering the to-be-sent data packet; and

sending currently buffered to-be-sent data packets to the game server at the same time when a graphics API instruction sequence comprising a synchronous calling instruction is intercepted, or when it is detected that an instruction queue of the game client is flushed.

In various embodiments, the method further includes:

adding a synchronous task comprising a synchronous instruction to the work queue when detecting that the game client performs game thread switching; and

sending the synchronous instruction in the synchronous task to the game server through the independent network IO thread, so that a GPU of the game server creates a synchronous object based on the synchronous instruction and executes a graphics API instruction sequence subsequent to the synchronous object after graphics API instruction sequences prior to the synchronous object are executed.

In various embodiments, the method further includes:

generating pseudo response information of a synchronous calling instruction and returning the pseudo response information to the game client when the intercepted graphics API instruction sequence includes the synchronous calling instruction; and

sending the pseudo response information to the game server so that the game server establishes and saves a correspondence between the pseudo response information and actual response information of the synchronous calling instruction.

The embodiments of the present application provide a live broadcast data processing method, applicable to a live broadcast system, the live broadcast system comprising a live broadcast provider terminal and a server that establish communication with each other, the method comprising following steps:

sending to the server, by the live broadcast provider terminal, a data execution instruction and graphic interaction data corresponding to the data execution instruction; and

processing, in response to the data execution instruction, by the server, the graphic interaction data and sending out an obtained graphic interaction picture.

In various embodiments, the live broadcast system further includes a live broadcast receiver terminal communicating with the server;

the step of sending to the server, by the live broadcast provider terminal, a data execution instruction and graphic interaction data corresponding to the data execution instruction includes a following step:

calling, after a live game is run, by the live broadcast provider terminal, interface parameters of an application programming interface corresponding to game resources in the live game to obtain the game resources of the live game, and sending the data execution instruction and the game resources to the server, wherein the graphic interaction data are the game resources; and

the step of processing, in response to the data execution instruction, by the server, the graphic interaction data and sending out an obtained graphic interaction picture includes following steps:

adjusting, in response to the data execution instruction, by the server, the game resources according to a setting rule and generating corresponding live broadcast cache data according to adjusted game resources, wherein the graphic interaction picture is the live broadcast cache data; and

sending, by the server, the live broadcast cache data to the live broadcast receiver terminal for playback.

In various embodiments, the setting rule includes preset viewing angle customization information; and

the step of adjusting, by the server, the game resources according to a setting rule includes:

calling, by the server, an interface instruction sequence and interface resources of a graphics application programming interface corresponding to the live game and adjusting a camera viewing angle in the game resources to a preset viewing angle in the preset viewing angle customization information; and

adjusting, by the server, the game resources based on the preset viewing angle to generate the adjusted game resources.

In various embodiments, the method further includes:

receiving, by the server, the preset viewing angle customization information sent by the live broadcast receiver terminal in response to a user operation; or

identifying, by the server, a game type of the live game and determining the preset viewing angle customization information according to the game type.

In various embodiments, the setting rule further includes game texture replacement information, and the game texture replacement information includes identification information of at least one to-be-replaced first game texture image and a second game texture image configured to replace each first game texture image; and

the step of adjusting, by the server, the game resources according to a setting rule includes:

calling, by the server, an interface instruction sequence and interface resources of a graphics application programming interface corresponding to the live game, and obtaining each to-be-replaced first game texture image from the game resources according to identification information of each first game texture image; and

replacing, by the server, each to-be-replaced first game texture image with a corresponding second game texture image to generate the adjusted game resources.

In various embodiments, the method further includes a following step:

configuring the setting rule by the server according to operating service information of a live broadcast platform.

In various embodiments, the step of configuring the setting rule by the server according to operating service information of a live broadcast platform includes following steps:

obtaining, by the server, an advertising content and an advertising rule of each advertiser from the operating service information;

determining, for each advertiser, by the server, identification information of a to-be-replaced first game texture image of the advertiser in the live game according to the advertising rule of the advertiser; and

generating, by the server, according to the advertising content of the advertiser, a second game texture image configured to replace each first game texture image.

In various embodiments, the step of determining, by the server, identification information of a to-be-replaced first game texture image of the advertiser in the live game according to the advertising rule of the advertiser includes:

obtaining, by the server, feature information of each game texture image in the live game; and

determining, by the server according to the feature information of each game texture image and the advertising rule of the advertiser, the identification information of the first game texture image, among various game texture images, that can display the advertising content of the advertiser;

the step of generating, by the server, according to the advertising content of the advertiser, a second game texture image configured to replace each first game texture image includes:

determine, by the server, advertising content corresponding to each first game texture image according to the identification information and the feature information of each first game texture image; and

adding, by the server, determined advertising contents to corresponding first game texture images, respectively, to generate corresponding second game texture images.

In various embodiments, the setting rule includes game audio customization information, and the game audio customization information includes identification information of at least one to-be-replaced first game audio and a second game audio configured to replace each first game audio; and

the step of adjusting, by the server, the game resources according to a setting rule includes:

calling, by the server, an interface instruction sequence and interface resources of an audio application programming interface corresponding to the live game, and obtaining each to-be-replaced first game audio from the game resources according to identification information of each first game audio; and

replacing, by the server, each to-be-replaced first game audio with a corresponding second game audio to generate the adjusted game resources.

In various embodiments, the method further includes:

receiving, by the server, game interception information sent by the live broadcast receiver terminal in response to a user operation, wherein the game interception information includes at least one of game image interception information and game element interception information;

obtaining, by the server, according to the game interception information, a corresponding target game image from the live broadcast cache data; and/or obtaining a corresponding target game element texture image from the game resources; and

sending, by the server, the target game image and/or the target game element texture image to the live broadcast receiver terminal.

In various embodiments, the step of calling, after a live game is run, by the live broadcast provider terminal, interface parameters of an application programming interface corresponding to game resources in the live game to obtain the game resources of the live game includes:

running, by the live broadcast provider terminal, a preset dynamic link library file in a running process of the live game after the live game is run, wherein the preset dynamic link library file includes a running program configured to intercept the interface parameters of the application programming interface of the live game, the application programming interface includes a graphics application programming interface and/or an audio application programming interface; and

obtaining, by the live broadcast provider terminal, the interface parameters of the application programming interface of the live game through the preset dynamic link library file and obtaining the game resources of the live game according to the interface parameters, wherein the game resources include game graphics resources and game audio resources.

In various embodiments, the step of sending to the server, by the live broadcast provider terminal, a data execution instruction and graphic interaction data corresponding to the data execution instruction includes following steps:

storing in a lock-free queue, by the live broadcast provider terminal, drawing instructions configured to render a picture and drawing parameters corresponding to the drawing instructions, wherein multiple drawing instructions are required to render one picture, the data execution instruction is the drawing instructions, the graphic interaction data are the drawing parameters; and

sending by the live broadcast provider terminal to the server the drawing instructions and the drawing parameters stored in the lock-free queue when detecting that a preset information sending condition is met;

the step of processing, in response to the data execution instruction, by the server, the graphic interaction data and sending out an obtained graphic interaction picture includes following steps:

performing picture rendering by the server according to the drawing instructions and the drawing parameters after receiving the drawing instructions and the drawing parameters; and

encoding, by the server, a rendered picture and sending an encoded picture to the live broadcast provider terminal after finishing the picture rendering, wherein the graphic interaction picture is the rendered picture; and

the method further includes a following step:

receiving, by the live broadcast provider terminal, the encoded picture, decoding a received picture and displaying a decoded picture.

In various embodiments, the step of storing in a lock-free queue, by the live broadcast provider terminal, drawing instructions configured to render a picture and drawing parameters corresponding to the drawing instructions includes:

serializing, by the live broadcast provider terminal, the drawing instructions configured to render a picture and the drawing parameters corresponding to the drawing instructions, and storing, in the lock-free queue, data obtained after the drawing instructions and the drawing parameters are serialized.

In various embodiments, the step of receiving, by the live broadcast provider terminal, the encoded picture, decoding a received picture and displaying a decoded picture includes following steps:

using an independent IO receiving thread by the live broadcast provider terminal to receive the encoded picture; and

decoding, by the live broadcast provider terminal, the encoded picture by means of hardware acceleration and displaying the decoded picture.

In various embodiments, the step of using an independent IO receiving thread by the live broadcast provider terminal to receive the encoded picture includes:

using the independent IO receiving thread by the live broadcast provider terminal to receive data obtained by serializing the encoded picture by the server, and deserializing received data to obtain the encoded picture.

In various embodiments, the step of performing picture rendering by the server according to the drawing instructions and the drawing parameters after receiving the drawing instructions and the drawing parameters includes:

disabling, by the server, a vertical synchronization function, deserializing the data sent by the live broadcast provider terminal to obtain the drawing instructions and the drawing parameters, and performing picture rendering according to the drawing instructions and the drawing parameters.

In various embodiments, the step of encoding, by the server, a rendered picture and sending an encoded picture to the live broadcast provider terminal after finishing the picture rendering includes:

obtaining, by the server, the rendered picture from a front-end buffer area of a graphics card; and

encoding, by the server, the rendered picture by means of hardware acceleration, serializing the encoded picture and storing, in a send queue, data obtained after serialization; and sending the data stored in the send queue to the live broadcast provider terminal according to a network status between the server and the live broadcast provider terminal.

In various embodiments, prior to the step of storing in a lock-free queue, by the live broadcast provider terminal, drawing instructions configured to render a picture and drawing parameters corresponding to the drawing instructions, the method further includes:

intercepting, by the live broadcast provider terminal, in response to a user-triggered picture rendering request, the drawing instructions configured to render a picture and the drawing parameters corresponding to the drawing instructions.

In various embodiments, the method further includes:

determining by the live broadcast provider terminal that the preset information sending condition is met when detecting at least one of an instruction for waiting for a synchronous object, an instruction for refreshing a buffer, a synchronous API calling instruction, and a rendering action instruction from an open graphics library.

In various embodiments, the live broadcast provider terminal is installed with a game client;

the step of sending to the server, by the live broadcast provider terminal, a data execution instruction and graphic interaction data corresponding to the data execution instruction includes following steps:

intercepting, by the live broadcast provider terminal, a graphics API instruction sequence initiated by the game client based on a control instruction input by a user, wherein the graphics API instruction sequence includes calling instructions, calling parameters and a calling order at the game client to graphics APIs, the graphic interaction data are the graphics API instruction sequence; and

sending to the server, by the live broadcast provider terminal, the data execution instruction and an intercepted graphics API instruction sequence according to an interception order; and

the step of processing, in response to the data execution instruction, by the server, the graphic interaction data and sending out an obtained graphic interaction picture includes following steps:

enabling a GPU, by the server in response to the data execution instruction, to execute the graphics API instruction sequence to obtain a rendered game picture and sending out the rendered game picture, wherein the graphic interaction picture is the rendered game picture.

In various embodiments, the step of intercepting, by the live broadcast provider terminal, a graphics API instruction sequence initiated by the game client based on a control instruction input by a user includes following steps:

encapsulating, by the live broadcast provider terminal, each intercepted graphics API instruction sequence into a task, and adding encapsulated tasks to a work queue according to the interception order; and

executing, by the live broadcast provider terminal, the tasks in the work queue sequentially through independent network IO thread and sending a graphics API instruction sequence in each task to the server.

In various embodiments, the step of executing, by the live broadcast provider terminal, the tasks in the work queue sequentially through independent network IO thread and sending a graphics API instruction sequence in each task to the server includes following steps:

processing, by the live broadcast provider terminal, the graphics API instruction sequence in each task in sequence into a to-be-sent data packet and buffering the to-be-sent data packet; and

sending, by the live broadcast provider terminal, currently buffered to-be-sent data packets to the server at the same time when a graphics API instruction sequence comprising a synchronous calling instruction is intercepted, or when it is detected that an instruction queue of the game client is flushed.

In various embodiments, the step of sending, by the live broadcast provider terminal, currently buffered to-be-sent data packets to the server at the same time includes:

compressing and encoding, by the live broadcast provider terminal, the currently buffered to-be-sent data packets and then sending compressed and encoded data packets to the server.

In various embodiments, the method further includes:

adding, by the live broadcast provider terminal, a synchronous task comprising a synchronous instruction to the work queue when detecting that the game client performs game thread switching;

sending, by the live broadcast provider terminal, the synchronous instruction in the synchronous task to the server through an independent network IO thread; and

creating, by a GPU of the server, a synchronous object based on the synchronous instruction and executing a graphics API instruction sequence subsequent to the synchronous object after graphics API instruction sequences prior to the synchronous object are executed.

In various embodiments, the method further includes:

generating, by the live broadcast provider terminal, pseudo response information of a synchronous calling instruction and returning the pseudo response information to the game client when an intercepted graphics API instruction sequence includes the synchronous calling instruction;

sending, by the live broadcast provider terminal, the pseudo response information to the server; and

establishing and saving, by the server, a correspondence between the pseudo response information and actual response information of the synchronous calling instruction.

In various embodiments, the live broadcast provider terminal intercepts, by calling a hook interface, the graphics API instruction sequence generated by the game client.

The embodiments of the present disclosure provide a live broadcast data processing method, applicable to a live broadcast provider terminal in a live broadcast system, the live broadcast system further comprising a server that establishes communication with the live broadcast provider terminal, the method comprising a following step:

sending a data execution instruction and graphic interaction data corresponding to the data execution instruction to the server so that the server processes the graphic interaction data in response to the data execution instruction and sends out an obtained graphic interaction picture.

In various embodiments, the step of sending a data execution instruction and graphic interaction data corresponding to the data execution instruction to the server includes:

calling, after a live game is run, interface parameters of an application programming interface corresponding to game resources in the live game to obtain the game resources of the live game, wherein the graphic interaction data are the game resources; and

sending the data execution instruction and the game resources to the server.

In various embodiments, the step of sending a data execution instruction and graphic interaction data corresponding to the data execution instruction to the server includes:

storing in a lock-free queue drawing instructions configured to render a picture and drawing parameters corresponding to the drawing instructions, wherein multiple drawing instructions are required to render one picture, the data execution instruction is the drawing instructions, the graphic interaction data are the drawing parameters; and

sending to the server the drawing instructions and the drawing parameters stored in the lock-free queue when detecting that a preset information sending condition is met; and

the method further includes:

receiving an encoded picture sent by the server, decoding a received picture and displaying a decoded picture, wherein the graphic interaction picture is the encoded picture.

In various embodiments, the live broadcast provider terminal is installed with a game client;

the step of sending a data execution instruction and graphic interaction data corresponding to the data execution instruction to the server includes:

intercepting a graphics API instruction sequence initiated by the game client based on a control instruction input by a user, wherein the graphics API instruction sequence includes calling instructions, calling parameters and a calling order at the game client to graphics APIs, the graphic interaction data are the graphics API instruction sequence; and

sending to the server the data execution instruction and an intercepted graphics API instruction sequence according to an interception order.

The embodiment of the present disclosure provide a live broadcast data processing method, applicable to a server in a live broadcast system, the live broadcast system further comprising a live broadcast provider terminal communicating with the server, the method comprising following steps:

receiving a data execution instruction sent by the live broadcast provider terminal and graphic interaction data corresponding to the data execution instruction; and

processing, in response to the data execution instruction, the graphic interaction data and sending out an obtained graphic interaction picture.

In various embodiments, the live broadcast system further includes a live broadcast receiver terminal communicating with the server, the graphic interaction data are game resources; and

the step of processing the graphic interaction data and sending out an obtained graphic interaction picture includes:

adjusting the game resources according to a setting rule and generating corresponding live broadcast cache data according to adjusted game resources, wherein the graphic interaction picture is the live broadcast cache data; and

sending the live broadcast cache data to the live broadcast receiver terminal for playback.

In various embodiments, the data execution instruction is a drawing instruction and the graphic interaction data are drawing parameters; and

the step of processing the graphic interaction data and sending out an obtained graphic interaction picture includes:

performing picture rendering according to the drawing instruction and the drawing parameters; and

encoding, after finishing the picture rendering, a rendered picture and sending an encoded picture to the live broadcast provider terminal, wherein the graphic interaction picture is the rendered picture.

In various embodiments, the graphic interaction data are a graphics API instruction sequence; and

the step of processing the graphic interaction data and sending out an obtained graphic interaction picture includes:

enabling a GPU to execute the graphics API instruction sequence to obtain a rendered game picture and sending out the rendered game picture, wherein the graphic interaction picture is the rendered game picture.

The embodiments of the present disclosure provide a live broadcast system, comprising a live broadcast provider terminal and a server that communicate with each other, wherein

the live broadcast provider terminal is configured to send a data execution instruction and graphic interaction data corresponding to the data execution instruction to the server; and

the server is configured to, in response to the data execution instruction, process the graphic interaction data and send out an obtained graphic interaction picture.

The embodiments of the present disclosure provide an electronic device, comprising a memory, a processor, and machine-executable instructions stored in the memory and executed in the processor, wherein the machine-executable instructions implement, when executed by the processor, the live broadcast data processing method.

The embodiments of the present disclosure provide a readable storage medium, having machine-executable instructions stored thereon, wherein the machine-executable instructions implement, when executed, the live broadcast data processing method.

The present disclosure is described in further detail by the following preferred embodiments.

Referring to FIG. 1, FIG. 1 shows a schematic diagram of an interaction scenario of a live broadcast system according to an embodiment of the present disclosure. In various embodiments, the live broadcast system may be configured as a service platform such as Internet live broadcast and the like. The live broadcast system may include a server, a live broadcast provider terminal, and a live broadcast receiver terminal. The server is in communication connection with the live broadcast provider terminal and the live broadcast receiver terminal, respectively. The server may be configured to provide a live broadcast service for the live broadcast provider terminal and the live broadcast receiver terminal.

It can be understood that the live broadcast system shown in FIG. 1 is only a feasible example. In other feasible embodiments, the live broadcast system may also include only a part of components shown in FIG. 1 or may also include other components. For example, the live broadcast system only includes a server and a live broadcast provider terminal, or only includes a server and a live broadcast receiver terminal.

Optionally, the live broadcast provider terminal and the live broadcast receiver terminal can be used interchangeably. For example, an MC at the live broadcast provider terminal can use the live broadcast provider terminal to provide a live video service to viewers, or view live videos provided by other MCs as a viewer. For another example, a viewer at the live broadcast receiver terminal can also use the live broadcast receiver terminal to watch live videos provided by MCs of interest, or serve as an MC to provide a live video service to other viewers.

Optionally, the live broadcast provider terminal and the live broadcast receiver terminal may be, but are not limited to, smart phones, personal digital assistants, tablet computers, personal computers, notebook computers, virtual reality terminal devices, augmented reality terminal devices, and the like. Here, the live broadcast provider terminal and the live broadcast receiver terminal may be each installed with an Internet product configured to provide an Internet live broadcast service. For example, the Internet product may be an application program APP, Web page, applet, and the like used in a computer or a smart phone and related to the Internet live broadcast service.

Optionally, the server may be a single physical server, or a server group composed of multiple physical servers configured to perform different data processing functions. The server group can be centralized or distributed (for example, the server may be a distributed system). Optionally, for a single physical server, different logical servers may be allocated to the physical server based on different live broadcast service functions.

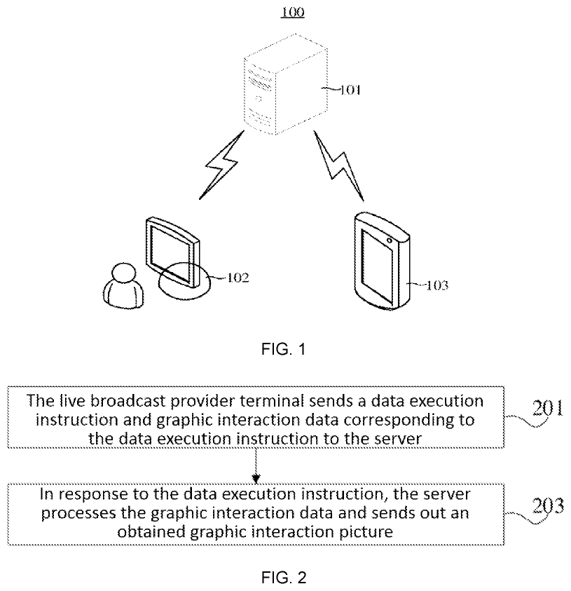

FIG. 2 shows a schematic flowchart of a live broadcast data processing method according to an embodiment of the present disclosure. The live broadcast data processing method may be applied to the live broadcast system shown in FIG. 1. In various embodiments, the live broadcast data processing method may include the following steps.

In step 201, the live broadcast provider terminal sends a data execution instruction and graphic interaction data corresponding to the data execution instruction to the server.

In step 203, in response to the data execution instruction, the server processes the graphic interaction data and sends out an obtained graphic interaction picture.

Optionally, the live broadcast provider terminal may perform data interaction with the server. For example, when the server is configured as a game server, by the data interaction between the live broadcast provider terminal and the server, the user at the live broadcast provider terminal side can experience cloud games, and the like; or when the server is configured as a live broadcast server, by the data interaction between the live broadcast provider terminal and the server, the user at the live broadcast provider terminal side can perform video live broadcasts and the like.

Here, when the live broadcast provider terminal performs data interaction with the server, the live broadcast provider terminal may send the data execution instruction and the graphic interaction data corresponding to the data execution instruction to the server. For example, the graphic interaction data may be a live picture in a live broadcast scenario, or game resources in a cloud game, or a to-be-rendered picture and rendering parameters required for the to-be-rendered picture, or the like.

Certainly, it is understandable that the foregoing is only an example. In some other implementations of the present disclosure, for example, in a live broadcast scenario combined with a virtual object, the foregoing graphic interaction data may also be interaction control data for the virtual object, such as behavior and action control data for the virtual object, morphological modification data (such as control data for clothing, accessories, and the like, for the virtual object), facial expression control data, or state control data of a space environment where the virtual object is located, and the like. The present disclosure does not limit the content included in the graphic interaction data; or in some other embodiments of the present disclosure, the interaction data sent by the live broadcast provider terminal to the server may not be limited to the above-mentioned graphic interaction data, for example, it may also include voice interaction data and the like.

Next, the server can process the graphic interaction data in response to the data execution instruction and send out the obtained graphic interaction picture. For example, in a scenario where the user experiences cloud games at the above live broadcast provider terminal side, the server may feed back to the live broadcast provider terminal a cloud game picture obtained after the processing, or may also send the cloud game picture to the live broadcast receiver terminal in FIG. 1.

In this way, according to the present disclosure, by configuring the process of processing the graphic interaction data at the server side of the live broadcast system, the data processing volume of the live broadcast provider terminal can be reduced, thereby reducing the hardware overhead of the live broadcast provider terminal and improving the live broadcast effect.

For example, in the live video scenario shown in FIG. 1, taking the game live broadcast as an example, some live broadcast strategies are as follows. an MC runs a live game and also runs a game screenshot application or the like to continuously get screenshots of the game and a live video stream is generated and sent to the server, and then the server forwards the live video stream to the live receiver terminal, so that the live game content can be completely presented to viewer clients.

However, in actual live broadcast scenarios, viewers may prefer to watch live game content that meets their own needs, rather than only live game content that meets the viewing needs of the MC. Because the traditional game live broadcast process usually sets the live game content, that is, the live game content watched by the viewers of the live broadcast receiver terminal must be consistent with the live game content watched by the MC at the live broadcast provider terminal side, the live broadcast content is not optimized and it is difficult to meet the diverse needs of the viewers.

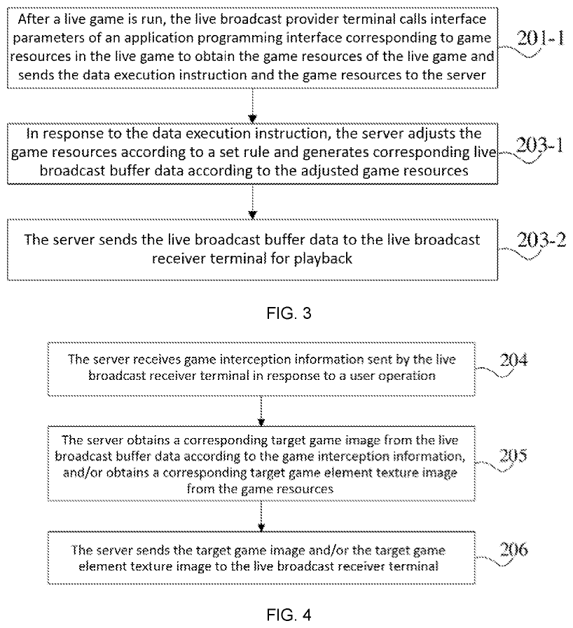

Therefore, in conjunction with FIG. 3, in the live broadcast scenario shown in FIG. 1, for example, in a game live broadcast scenario, the aforementioned graphic interaction data may be game resources, and the aforementioned graphic interaction picture may be live broadcast cache data.

Thus, in this scenario, step 201 may include the following sub-step.

In step 201-1, after a live game is run, the live broadcast provider terminal calls interface parameters of an application programming interface corresponding to game resources in the live game to obtain the game resources of the live game and sends the data execution instruction and the game resources to the server.

In addition, step 203 may include the following sub-steps.

In step 203-1, in response to the data execution instruction, the server adjusts the game resources according to a setting rule and generates corresponding live broadcast cache data according to the adjusted game resources.

In step 203-2, the server sends the live broadcast cache data to the live broadcast receiver terminal for playback.

Optionally, the live broadcast provider terminal may be installed with multiple live games. Before the user at the live broadcast provider terminal side (i.e., the MC) starts a broadcast, the MC selects a live game to be played, such as a Multiplayer Online Battle Arena (MOBA) game and the like, in a live broadcast room through an interactive interface of the live broadcast provider terminal and then runs the live game at the live broadcast provider terminal.

After the live game runs, the live game exists in the process (course) of the live broadcast provider terminal. In this case, the live broadcast provider terminal can run a preset Dynamic Link Library (DLL) file in the running process of the live game.

Here, the preset Dynamic Link Library file may include a running program configured to intercept the interface parameters of the Application Programming Interface (API) of the live game. Optionally, the Application Programming Interface may include a graphics Application Programming Interface and an audio Application Programming Interface, or the Application Programming Interface may also be one of the graphics Application Programming Interface and the audio Application Programming Interface.

Exemplarily, taking the Application Programming Interface including a graphics Application Programming Interface and an audio Application Programming Interface as an example, the running program may store an implementation process of a function (sub-process) configured to intercept the interface parameters of the graphics Application Programming Interface and the audio Application Programming Interface of the live game. After the live game is run on the live broadcast provider terminal, the live broadcast provider terminal can obtain the interface parameters of the graphics Application Programming Interface of the live game through the preset Dynamic Link Library file and obtain the game resources of the live game according to the interface parameters. Optionally, the game resources may include game graphics resources and game audio resources.

Optionally, if the Application Programming Interface only includes a graphics Application Programming Interface, then the game resource can be a game graphics resource. Correspondingly, if the Application Programming Interface only includes the audio Application Programming Interface, then the game resources are game audio resources.

Optionally, the foregoing graphics Application Programming Interface may include, but is not limited to, programming interfaces such as DirectX, OpenGL, Vulkan, and the like through which the game resources of the live game can be rendered.

Optionally, game graphics resources may include, but are not limited to, texture resources, Shader resources, cache resources, and the like of the live game. For example, texture resources may refer to pixel representation resources of programming interfaces such as DirectX, OpenGL, Vulkan, and the like; Shader resources may refer to rendering and coloring resources; cache resources may refer to resources such as various picture models in the live game.

On the basis of the above, the live broadcast provider terminal can send the obtained game resources and the data execution instruction together to the server. In this way, the server may respond to the data execution instruction and adjust the game resources to generate corresponding live broadcast cache data and then send the live broadcast cache data to the live broadcast receiver terminal for playback. In this way, by personalizing the game resources of the live game at the server side according to the viewing needs of the viewers, the live game content that meets the viewing needs of the viewers is provided to the viewers, thereby increasing the viewer's enthusiasm for viewing and increasing the operating traffic of the viewers.

Optionally, for step 203-1, the setting rule may be selected according to different application scenarios.

For example, according to the research of the inventor of the present disclosure, for example, in a scenario where a 3D game is used as a live game, in order to win the competition during the game, the MC usually chooses the best viewing angle of the competition as the game MC's viewing angle. However, the best viewing angle of the competition of the MC is not necessarily the best viewing angle of viewers. If the best viewing angle of the competition of the MC is used as the viewing angle of the viewers like in other live broadcast solutions, it will inevitably lead to a decrease in the viewing experience of the viewers and affect the viewer's enthusiasm for viewing.

On this basis, in order to enhance the viewing effect of the live broadcast, the setting rule may include preset viewing angle customization information. For example, optionally, the viewer can personalize the preset viewing angle customization information on the live broadcast receiver terminal and send the preset viewing angle customization information to the server to customize the viewing angle of the live game, such as the first-person or third-person viewing angle of the MC's game character, or the back, upper, or side viewing angle of the MC's game character, or the viewing angle of a game character other than the MC' game character, or the like, and it is not specifically limited in the present disclosure.

For another example, the server may also identify the game type of the live game, and determine the preset viewing angle customization information according to the game type. For example, for 3D games in the adventure and survival series, the best viewing angle of the viewers is usually the third-person viewing angle, so the server can determine the preset viewing angle customization information as the third-person viewing angle.

On this basis, the server can pre-configure an interface instruction sequence and interface resources of the graphics Application Programming Interface corresponding to the live game, so that the interface instruction sequence and interface resources of the graphics Application Programming Interface corresponding to the live game can be called, a camera viewing angle in the game resources (game graphics resources) is adjusted to a preset viewing angle in the preset viewing angle customization information, and then the game resources are adjusted according to the above-mentioned preset viewing angle to generate the adjusted game resources.

For example, if the camera viewing angle in the game resources is the first-person viewing angle of the MC's game character, and the preset viewing angle in the preset viewing angle customization information is the third-person viewing angle, the server can call the interface instruction sequence and interface resources of the graphics Application Programming Interface corresponding to the live game, and adjust the first-person viewing angle of the MC's game character in the game resources to a second-person viewing angle.

In this way, according to the solution in the present disclosure, the viewing angle of the live picture can be freely customized, thereby providing a more delicate and astonishing game viewing angle experience and improving the viewer's enthusiasm for viewing.

In addition, in various embodiments, according to the research of the inventor of the present disclosure, some game live broadcast solutions do not have deep secondary processing capabilities. If an advertisement needs to be placed on the traditional game live broadcast picture, the advertising content is usually drawn on the video stream of the MC directly. However, this form of advertising content usually has a fixed position in the live picture, which will obscure the important content of the live picture; and the viewing effect of the advertisement is poor, which seriously affects the viewer's live broadcast viewing experience.

On this basis, in order to improve the advertising effect, optionally, the setting rule may also include game texture replacement information, and the game texture replacement information may include identification information of at least one to-be-replaced first game texture image and a second game texture image configured to replace each first game texture image.

Here, the first game texture image may refer to a game texture image that originally exists in the live game, for example, it may be a texture image of a game prop, a road surface, a wall, or the like in the live game. The second game texture image may refer to a game texture image that includes advertising content, such as a texture image of a game prop, a road surface, or a wall with printed Logo of each advertisement.

Exemplarily, optionally, the server may configure the setting rule according to operating service information of a live broadcast platform. The operating service information may refer to advertising service information purchased by advertisers on the live broadcast platform, and may include, for example, the advertising content and advertising rule of each advertiser. The advertising content may refer to the promotion content of an advertised product provided by the advertiser, for example, it may be a product Logo, a product slogan, and the like. The advertising rule may refer to an advertising rule corresponding to an advertising service selected by an advertiser, and the live broadcast platform may determine different advertising service fees according to different advertising services.

On this basis, optionally, the server may first obtain the advertising content and advertising rule of each advertiser from the operating service information. Then, for each advertiser, the server may determine the identification information of the to-be-replaced first game texture image of the advertiser in the live game according to the advertising rule of the advertiser, and then generate, according to the advertising content of the advertiser, a second game texture image configured to replace each first game texture image.

Optionally, the server may obtain feature information of each game texture image in the live game, for example, the appearance frequency and image size of each game texture image in the game scenario of the live game. Then, according to the feature information of each game texture image and the advertising rule of the advertiser, the identification information of the first game texture image, among various game texture images, that can display the advertising content of the advertiser is determined. For example, the advertising rule may include the appearance frequency, image size and other rules required by the advertiser. The advertising rule of the advertiser is matched with the feature information of each game texture image, and the identification information of the first game texture image, among various game texture images, that can be used to display the advertising content of the advertiser is determined according to the matching situation.

On this basis, the server can determine the advertising content corresponding to each first game texture image according to the identification information and feature information of each first game texture image, and then respectively add the determined advertising contents to their corresponding first game texture images to generate the corresponding second game texture images.

Therefore, when adjusting the game resources of the live game, the server can call the interface instruction sequence and interface resources of the graphics Application Programming Interface corresponding to the live game, obtain each to-be-replaced first game texture image from the game resources according to the identification information of each first game texture image, and replace each to-be-replaced first game texture image with a corresponding second game texture image to generate adjusted game resources.

In this way, by deeply combining the advertising content with the game content, the advertising content is directly drawn into the specific game scenario, which effectively avoids a situation where the advertising content obstructs the important content of the live broadcast picture. In this way, the viewing effect of the advertisement is improved and the live broadcast screen of the live broadcast provider terminal is not affected.

In addition, in another example, according to the research of the inventor of the present disclosure, in some game live broadcast solutions, audio information in the game is usually developed and designed by a game developer and cannot be adjusted. However, for different viewers, they hope that the game audio can be more in line with their own hobbies, styles and habits.

On this basis, in order to improve the viewer experience, the setting rule may include game audio customization information. The game audio customization information includes identification information of at least one to-be-replaced first game audio and a second game audio configured to replace each first game audio. Here, the first game audio may refer to a game audio that originally exists in the live game, for example, it may be a game audio such as a scenario audio, a dialog audio, a skill audio, and an action audio in the live game. The second game audio may refer to an adjusted game audio, such as scenario audio after addition of an advertisement, a dialog audio after adjustment of audio style, a skill audio and an action audio after enhancement of an audio effect, and the like, which are not specifically limited here.

Exemplarily, optionally, the server may call interface instruction sequence and interface resources of an audio Application Programming Interface corresponding to the live game, obtain each to-be-replaced first game audio from the game resources (game audio resources) according to the identification information of each first game audio, and then replace each to-be-replaced first game audio with a corresponding second game audio to generate adjusted game resources. In this way, the audio content of the live audio can be freely customized, so as to provide viewers with a live broadcast viewing experience that is more in line with their own needs and improve viewers' enthusiasm for viewing.

Exemplarily, in another example, according to the research of the inventor of the present disclosure, some game live broadcast solutions do not have the ability to extract game elements. When the MC wins the competition in the live game or forms a competitive advantage in the live game, if the live broadcast receiver terminal needs to save this scenario on file, generally it is required to directly save a screenshot of the live game picture. However, the screenshots saved in the above solution are of lossy image quality, because the live game video stream is usually transmitted to the live broadcast receiver terminal after lossy compression and the live game video stream is usually combined with MC information (such as MC ID, MC avatar, and the like), advertising content, and the like, the live broadcast receiver terminal generally cannot save the lossless native game screenshots. In addition, if the live broadcast receiver terminal needs to save a texture image of a certain game element in the live game, for example, a texture image of a road surface in the live game, the above solution cannot be implemented.

On this basis, optionally, referring to FIG. 4, subsequent to step 203-2, the live broadcast data processing method may further include the following steps.

In step 204, the server receives game interception information sent by the live broadcast receiver terminal in response to a user operation.

Optionally, the game interception information may include at least one of game image interception information and game element interception information. Here, the game image interception information may include target time corresponding to a game image required to be intercepted, and the target time may be the current time or a certain time prior to the current time. For example, the target time can be the current moment by default, and meanwhile, time options may also be provided and can be specifically selected by a viewer. For example, when the viewer finds that a to-be-intercepted game image has been missed, if, however, a specific range of live broadcast time is known, the target time can be determined by selecting the range of the live broadcast time, so as to avoid missing the interception of a wonderful picture. The game element interception information may include identification information of a game element texture image required to be intercepted, such as the identification information of a road surface texture image, a wall texture image or an equipment texture image.

In step 205, the server obtains a corresponding target game image from the live broadcast cache data according to the game interception information, and/or obtains a corresponding target game element texture image from the game resources.

In step 206, the server sends the target game image and/or the target game element texture image to the live broadcast receiver terminal.

Optionally, if the game interception information only includes the game image interception information, the server may obtain the corresponding target game image from the live broadcast cache data, and send the target game image to the live broadcast receiver terminal. If the game interception information only includes the game element interception information, the server may obtain the corresponding target game element texture image from the game resources (game graphics resources), and send the target game element texture image to the live broadcast receiver terminal. If the game interception information includes the game image interception information and the game element interception information, the server may obtain the corresponding target game image from the live broadcast cache data, and obtain the corresponding target game element texture image from the game resources (game graphics resources), and then send the target game image and the target game element texture image to the live broadcast receiver terminal.

It should be noted that the server may also identify a game event in each frame of the game picture in the live broadcast cache data, and when identifying that a game event in a certain frame of the game picture is a target event (for example, a competitive victory), the server sends the frame of the game picture to the live broadcast receiver terminal, and the live broadcast receiver terminal chooses whether to save the frame of the game picture.

In this way, a screenshot operation is performed on the server according to the game interception information sent by the live broadcast receiver terminal. Since the live broadcast cache data in the server is of lossless image quality and does not combine other information such as the MC information and the advertising content, it can be ensured that the target game image received by the viewers is a lossless native game screenshot. In addition, since the server includes game resources of the live game, when the live broadcast receiver terminal needs to save a certain game element texture image in the live game, the game element texture image can be intercepted from the game resources through the server.

Exemplarily, optionally, for step 201-1, the live broadcast provider terminal may run a preset Dynamic Link Library file in the running process of the live game after the live game is run, wherein the preset Dynamic Link Library file includes a running program configured to intercept the interface parameters of the Application Programming Interface of the live game, the Application Programming Interface may include a graphics Application Programming Interface and an audio Application Programming Interface, or the Application Programming Interface may include one of the graphics Application Programming Interface and the audio Application Programming Interface. Then, the interface parameters of the graphics Application Programming Interface of the live game are obtained through the preset Dynamic Link Library file, and the game resources of the live game are obtained according to the interface parameters. The game resources include game graphics resources and game audio resources.

In addition, in a scenario such as cloud rendering, the server can run a cloud rendering platform, and the live broadcast provider terminal can send a to-be-rendered picture to the server. After the server renders the to-be-rendered picture, the rendered picture is sent for display, for example, the rendered picture is sent to the live broadcast provider terminal for display, or the rendered picture is sent to the live broadcast receiver terminal for display. Here, the server generally has more powerful software resources and hardware resources than terminal devices such as a live broadcast provider terminal or a live broadcast receiver terminal, and thus can render the picture faster.

However, since cloud rendering generally needs to be completed by means of data communication between the terminal device and the server, it takes time for the terminal device to send the to-be-rendered picture to the server, which will increase the time of the entire cloud rendering process, cause the delay of cloud rendering, and reduce the efficiency of cloud rendering.

For this reason, according to the inventor's research, the time required for cloud rendering of the picture is mainly composed of following parts: first, time required for the terminal device to send drawing instructions configured to render the picture and drawing parameters to the server; second, time required for the server to perform picture rendering according to the drawing instructions and the drawing parameters; third, time required to perform compressing, encoding and other processes on the rendered picture; fourth, time required to send the encoded picture to the terminal device through a network; and fifth, time required for the terminal device to decode the encoded picture to obtain the picture.

In order to reduce the time required for cloud rendering and reduce cloud rendering delay, the inventor provides the following solution through research.

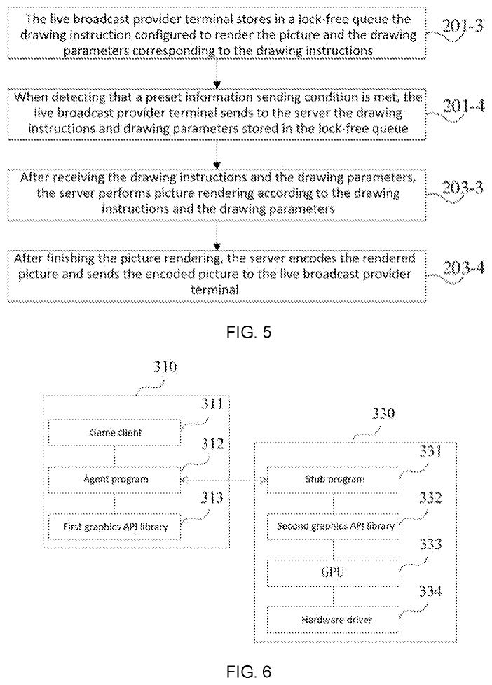

Referring to FIG. 5, in a scenario such as cloud rendering, the foregoing data execution instruction may refer to drawing instructions, and the foregoing graphic interaction data may be drawing parameters.

In this way, optionally, step 201 may further include the following sub-steps.

In step 201-3, the live broadcast provider terminal stores in a lock-free queue the drawing instruction configured to render the picture and the drawing parameters corresponding to the drawing instructions.

Optionally, in response to a user-triggered picture rendering request, the live broadcast provider terminal may generate drawing instructions configured to perform picture rendering and corresponding drawing parameters. After intercepting the above drawing instructions and drawing parameters, the live broadcast provider terminal can perform serialized treatment on the drawing instructions and drawing parameters, and store in the lock-free queue the data obtained after serializing the drawing instructions and drawing parameters. Serializing refers to a process of converting the state information of an object into a form that can be stored or transmitted, that is, the process of converting the drawing instructions and drawing parameters into a byte stream in the present disclosure. Storing data in a lock-free queue can ensure that in an scenario of one enqueue thread and one dequeue thread, the two threads can operate concurrently and thread safety can be guaranteed without any locking behavior. That is, the use of a lock-free queue to store data can ensure the efficiency of data storage and retrieval while ensuring the safety of data storage and retrieval.

Optionally, multiple drawing instructions are required to render a picture, and each drawing instruction corresponds to a drawing parameter configured to complete the drawing instruction task. The drawing parameters include texture parameters, color parameters, and the like.

The live broadcast provider terminal stores the drawing instructions and drawing parameters in the lock-free queue, instead of directly calling an IO send thread for immediate processing of the intercepted drawing instructions and corresponding drawing parameters. For example, the rendering of a picture requires 1000 drawing instructions. If each drawing instruction calls the IO send thread once, the IO send thread needs to be called 1000 times. If the data obtained after serializing is stored in the lock-free queue and then sent when a sending condition is met, the multiple drawing instructions can be sent out by calling the IO send thread once. In this way, the number of calls to the IO send thread can be reduced, and the number of context switches can be reduced. Here, a context switch refers to a process in which a Central Processing Unit (CPU) saves the state of the previous task and loads the next task.

Optionally, taking the use of Open Graphics Library (OpenGL) for picture rendering as an example, the live broadcast provider terminal can instantiate the intercepted OpenGL drawing instructions into various GLTask subclasses (drawing instructions and drawing parameters), serialize the GLTask, and then put the serialized GLTask into the lock-free queue. Instantiation refers to a process of creating objects with classes in object-oriented programming.

In step 201-4, when detecting that a preset information sending condition is met, the live broadcast provider terminal sends to the server the drawing instructions and drawing parameters stored in the lock-free queue.

Optionally, the live broadcast provider terminal can detect whether the live broadcast provider terminal itself satisfies the preset information sending condition. Exemplarily, taking the use of OpenGL for picture rendering as an example, when detecting any one of a “waiting for a synchronous object” instruction (wait), a “refreshing the buffer” instruction (flush), a synchronous API calling instruction (get*), and a rendering action instruction (draw*) of OpenGL, the live broadcast provider terminal can determine that the live broadcast provider terminal meets the preset information sending condition, and when the live broadcast provider terminal meets the preset information sending condition, the drawing instructions and corresponding drawing parameters stored in the lock-free queue are sent in batches, which can reduce the number of calls to the IO send thread and save time for the live broadcast provider terminal to send the data.

In addition, optionally, step 203 may include the following sub-steps.

In step 203-3, after receiving the drawing instructions and the drawing parameters, the server performs picture rendering according to the drawing instructions and the drawing parameters.

In step 203-4, after finishing the picture rendering, the server encodes the rendered picture and sends the encoded picture to the live broadcast provider terminal. Here, the above-mentioned graphic interaction picture refers to the rendered picture.

Moreover, in the aforementioned cloud rendering scenario, for example, the live broadcast data processing method may further include the following step.

In step 207, the live broadcast provider terminal receives the encoded picture, decodes the received picture and displays the decoded picture.

Optionally, the live broadcast provider terminal may first store the intercepted drawing instructions and drawing parameters in the lock-free queue, and then send in batches the drawing instructions and drawing parameters stored in the lock-free queue when detecting that the preset information sending condition is met. In this way, the number of calls to the IO thread to send the data is reduced, that is, the number of context switches is reduced, and thus the time consumption of the live broadcast provider terminal for sending the data can be reduced. The above method can reduce the time required for the live broadcast provider terminal to send the drawing instructions and drawing parameters to the server during the cloud rendering process, thereby reducing the time consumption of the entire cloud rendering process and reducing the delay of the entire cloud rendering process.

In addition, in order to reduce the time consumption for the server to render the picture during the cloud rendering process, the following is provided. According to the inventor's research, in the case where the picture rendering is performed on the live broadcast provider terminal, in order to prevent tearing of the picture rendered on the live broadcast provider terminal, the frame rate per second is generally limited (for example, no more than 60 frames per second). In order to limit the frame rate per second, the live broadcast provider terminal generally enables a vertical synchronization (vsync) function. In the present disclosure, the picture rendering action is completed by the server and the server does not display the rendered picture.

Therefore, in order to reduce the time required for the server to render the picture, step 203-3 can be implemented as follows.

The vertical synchronization function in the server is disabled, and picture rendering is performed according to the drawing instructions and the drawing parameters.

By disabling the vertical synchronization function, the frame rate of the rendered picture can be increased (for example, 200 frames per second). In this way, the rendering speed of the picture per unit time can be increased and the time consumed for rendering each picture and the delay of the entire cloud rendering process can be reduced.

The server receives the byte stream sent by the live broadcast provider terminal, deserializes the received byte stream to obtain the drawing instructions and the drawing parameters, and performs picture rendering according to the obtained drawing instructions and drawing parameters. Here, the deserialization refers to a reverse process of creating an object from a byte stream. In the present disclosure, the server may use the protobuf protocol to implement serialization and deserialization.

Exemplarily, in order to reduce the time required for the server to compress and encode the rendered picture, the following is provided. According to the inventor's research, most window systems use double buffer areas (for example, including a front-end buffer area and a back-end buffer area) for picture buffering in order to avoid picture tearing and flickering. Since the picture in the front-end buffer area is displayed on a screen and rendering takes place in the back-end buffer area, images buffered in the front-end buffer area and the back-end buffer area differ by one frame. In other words, the picture that the human eye sees through the screen is delayed. In the present disclosure, picture rendering is performed on the server. Only when the buffer areas are exchanged can it be determined whether the picture rendering is completed. Before the action of exchanging the buffer areas is completed, the picture stored in the back-end buffer area is the latest picture. After the action of exchanging the buffer areas is completed, the picture stored in the front-end buffer area is the latest picture. The action of encoding occurs after the buffer areas are exchanged, and the front-end buffer area must be used to ensure that the encoded content is the latest picture content.

In order to reduce the time required for the server to compress and encode the rendered picture, step 203-4 can be implemented as follows.

First, the server obtains the rendered picture from the front-end buffer area of a graphics card.

Next, the server encodes the rendered picture by means of hardware acceleration, and sends the encoded picture to the live broadcast provider terminal.

The server can ensure that a latest rendered picture is obtained by copying the picture from the front-end buffer area. During encoding, the server can directly encode the acquired rendered picture by means of hardware acceleration to obtain a H264 or H265 code stream. Then, the server can send the encoded code stream to the live broadcast provider terminal. Hardware acceleration is a technology for computer equipment to reduce the workload of the central processing unit by allocating computationally intensive work to specialized hardware to process. Through hardware acceleration, the central processing unit and the graphics processing unit can perform encoding at the same time, which reduce the encoding time.

In order to ensure that the encoding process does not block the picture rendering process of the server, in the present disclosure, an independent encoding thread is used to encode the rendered picture. The encoding thread can interact with the thread for picture rendering through a synchronization mechanism, so as to ensure the normal progress of picture rendering and encoding.

Optionally, when the server sends the encoded code stream to the live broadcast provider terminal, first, the server can serialize the encoded code stream, and store in a send queue the data obtained after serialization; then, according to the network status between the server and the live broadcast provider terminal, the data in the send queue is sent to the live broadcast provider terminal. Exemplarily, the server can dynamically adjust the data transmission rate according to the network status between the server and the live broadcast provider terminal, so as to avoid data loss due to poor network status during data transmission based on the Transmission Control Protocol (TCP).

In addition, optionally, in order to reduce the time required for sending the encoded picture to the live broadcast provider terminal via a network during the cloud rendering of the picture and the time required for the live broadcast provider terminal to decode the picture, the following is provided. In the present disclosure, step 207 can be implemented as follows.

First, the live broadcast provider terminal uses an independent IO receiving thread to receive the encoded picture.

The live broadcast provider terminal uses an independent IO receiving thread to receive the data sent by the server, and deserializes the received data to obtain the encoded picture. Using the independent IO receiving thread relative to the IO send thread to receive data can reduce the mutual influence between data sending and data receiving, improve the efficiency of data receiving and sending, and reduce the time consumed by the live broadcast provider terminal to receive and send data.

Then, the live broadcast provider terminal decodes the encoded picture by means of hardware acceleration, and displays the decoded picture.

The live broadcast provider terminal performs decoding by means of hardware acceleration in a similar way to the above encoding method, and thus it will not be repeated here.

In addition, in scenarios such as the above-mentioned game live broadcast, for some client game architectures, in order to run the entire game client on a user-side device, for example, in the game live broadcast scenario, the game client is generally deployed on the live broadcast provider terminal. In order to smoothly render the game picture, the user-side device generally needs a graphics card that supports hardware acceleration. The core of the graphics card is the Graphics Processing Unit (GPU). Due to the insufficient hardware performance of the user-side device itself, the wide application of the game client is limited.

Therefore, in order to reduce the computing power requirements of the game client on the GPU, for example, in cloud games and other scenarios, some strategies are to deploy a complete game client and an agent program on a cloud server. The agent program can be configured to receive control instructions from the user-side device and forward the control instructions to the game client for processing, and after obtaining a corresponding game picture by rendering, encode the game picture into a video code stream and return the video code stream to the user-side device for decoding and playback. However, the hardware cost and development cost of this method are both very high.

For this reason, according to the inventor's research, the processing flow of the game client in running is as follows: the game client processes a control instruction input by a user according to a game logic, determines a game picture triggered by the control instruction, and then determines a graphics Application Programming Interface (API) required to render the game picture, and calls the determined graphics API to communicate with a driver of underlying hardware (such as the GPU) of a device where the game client is located, to enable a corresponding function of the GPU to render the game picture. In the above-mentioned processing flow, processing the control instruction to determine the to-be-called graphics API is implemented by virtue of the Central Processing Unit (CPU), and calling the graphics API to implement the corresponding rendering is implemented by virtue of the GPU.

Based on the above findings, the present disclosure cleverly decouples the processing flow of the game client into two parts: CPU processing flow and GPU processing flow. The CPU processing flow is deployed on a user-side electronic device, such as the live broadcast provider terminal. The GPU processing flow is deployed on the server, and the GPU required for rendering is deployed on the server. In this way, compared to some methods of deploying a complete game on the server, the solution of the embodiment can reduce the processing operations required to be executed by the server without changing the hardware configuration of the server, thus reducing the performance requirements for the server. As the complexity of the program after decoupling is reduced, the subsequent upgrade and maintenance of the program will also become easier. In addition, the computing power required to process the control instruction according to the game logic is relatively low, and it can be reached just by an ordinary electronic device (such as a personal computer, a smart terminal and the like), so the device cost of the user side will not increase.

On the basis of this, optional embodiments of the live broadcast data processing method according to the present disclosure will be described below.

As shown in FIG. 1 and FIG. 6, the above-mentioned electronic device may be configured as the live broadcast provider terminal in FIG. 1 or the live broadcast receiver terminal in FIG. 1. In addition, optionally, the server in FIG. 1 may be configured as a game server. Optionally, the above-mentioned electronic device may be configured as any device that has data processing and display functions and is in communication connection with the game server, such as a notebook computer, a tablet computer, a television, a smart terminal, and other devices that have simple data processing, video decoding and playback capabilities, but have a weak rendering capability and are difficult to directly run big games.

Optionally, the aforementioned electronic device may include a game client, a proxy program, and a first graphics Application Programming Interface (API) library. Here, the game client may be configured as a 3D game application developed based on a 3-Dimension (3D) engine, and the 3D engine may be Unreal Engine 4 (UE4), Unity, or the like, for example. The proxy (agent) program can be set in the game client. In other words, the game client can serve as a host program of the proxy program.

Optionally, the server may include a second graphics API library, a GPU, a hardware driver, and a stub program that communicates with the proxy program of each game client, for example, the stub program that communicates with the proxy program shown in FIG. 2. The GPU can support hardware acceleration. For example, when the game client is a 3D game application, the GPU can support 3D hardware acceleration.

Optionally, the first graphics API library and the second graphics API library may be the same graphics API library, such as OpenGL, DirectX, Vulkan, and the like, including APIs configured to render 2D and 3D vector graphics. By calling these APIs, communication with the driver of the underlying hardware (e.g., the GPU) can be established to enable the graphics processing function of the underlying hardware.

The application of the live broadcast data processing method according to the present disclosure in scenarios such as the aforementioned cloud game is exemplarily illustrated in the following by taking the live broadcast provider terminal in FIG. 1, where a game client is installed, as an example.

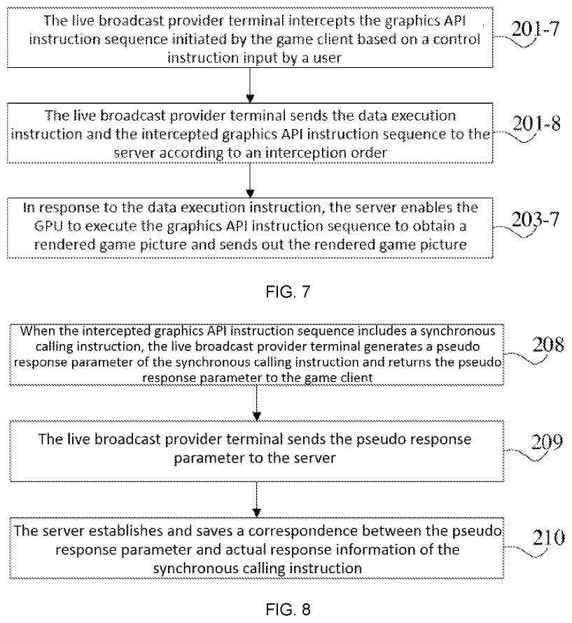

Referring to FIG. 7, optionally, the above-mentioned graphic interaction data may be a graphics API instruction sequence; and, step 201 may include the following sub-steps. In step 201-7, the live broadcast provider terminal intercepts the graphics API instruction sequence initiated by the game client based on a control instruction input by a user.

In step 201-8, the live broadcast provider terminal sends the data execution instruction and the intercepted graphics API instruction sequence to the server according to an interception order.

In addition, optionally, step 203 may include the following sub-steps.

In step 203-7, in response to the data execution instruction, the server enables the GPU to execute the graphics API instruction sequence to obtain a rendered game picture and sends out the rendered game picture.

Optionally, the user can input the control instruction to the game client in the live broadcast provider terminal through a keyboard, a mouse, a joystick, a voice input device, and the like; the game client processes the control instruction according to a preset game logic and the game picture corresponding to the control instruction can be determined.

For example, when the user inputs a control instruction c1 configured to control a game character A to raise his or her hand, the game picture corresponding to the control instruction c1 shows a picture in which the game character A raises his or her hand. For another example, when the user inputs a control instruction c2 for controlling the game character A to use a game skill t1, the game picture corresponding to the control instruction c2 shows a picture in which the game character A uses the game skill t1 and corresponding special effects are produced.

After determining the game picture corresponding to the control instruction input by the user, the game client can further determine a graphics API required to be called to render the game picture and calling parameters of the determined graphics API. For each determined graphics API, a calling instruction configured to call the graphics API can be generated. The calling instruction and the corresponding calling parameters are usually sent to the hardware driver of the GPU of the device where the game client is located, so that the calling instruction is converted into a corresponding GPU instruction for execution by the GPU, thereby performing rendering to obtain a game picture. Here, the rendering of each frame of game picture generally needs to call multiple graphics APIs in a certain order. Therefore, a graphics API instruction sequence is generally generated and initiated by the game client and the graphics API instruction sequence includes calling instructions, calling parameters and a calling order to multiple graphics APIs.

Optionally, the live broadcast provider terminal generally does not have a GPU that supports 3D hardware acceleration, that is, it cannot execute the aforementioned graphics API instruction sequence. Therefore, optionally, the live broadcast provider terminal intercepts all graphics API instruction sequences initiated by its host program (i.e., the game client) through an agent program. For example, the interception may be implemented through a hook interface. In this way, all graphics API instruction sequences initiated by the game client will be processed in accordance with a processing flow defined in the hook interface, instead of being sent to the hardware driver of the live broadcast provider terminal.

Exemplarily, considering that the game client usually initiates the graphics API instruction sequence in sequence according to an actual execution order, the interception order of the graphics API instruction sequences intercepted by the hook interface is generally the actual execution order. Then, the processing flow as shown in step 201-8 can be defined in the hook interface, so that each intercepted graphics API instruction sequence is sent, according to the interception order, to the server for execution in sequence.

Considering that graphics API calling is very frequent at the game client, optionally, the agent program generally needs to send intercepted graphics API instruction sequences through the network very frequently, that is, a large number of network IO (Input Output) operations are required. In addition, the game client is a computationally intensive program, that is, the call thread occupies a high load in the processor of the live broadcast provider terminal. In order to avoid affecting other threads of the live broadcast provider terminal, optionally, the live broadcast provider terminal may send the intercepted graphics API instruction sequences through configured independent network IO (input output) thread.

Exemplarily, the agent program in the live broadcast provider terminal can encapsulate a task for each intercepted graphics API instruction sequence, and add the encapsulated tasks to a work queue according to the interception order. For example, assuming that the graphics API instruction sequences s1, s2, and s3 are intercepted in sequence, and then s1 can be encapsulated as task1, s2 can be encapsulated as task2, and s3 can be encapsulated as task3, and then task1, task2, and task3 can be added to the work queue in sequence. In this way, an arrangement order of the tasks in the work queue is consistent with the actually required execution order of the graphics API instruction sequences in the tasks.

On this basis, the tasks in the work queue are executed sequentially through the network IO thread that are independent of other threads in the live broadcast provider terminal, and the graphics API instruction sequence in each task is sent to the server. In this way, it can be ensured that the order in which the server receives and executes the graphics API instruction sequences is consistent with the actually required execution order, and it can also avoid affecting other threads in the live broadcast provider terminal.

In order to avoid frequent network IO operations, optionally, the live broadcast provider terminal may sent the intercepted graphics API instruction sequences in combination. Exemplarily, when the above-mentioned independent network IO thread executes each task, the graphics API instruction sequence in the task can be processed into a to-be-sent data packet and buffered. After buffering for a certain interval of time, the to-be-sent data packets buffered in this time interval are sent to the server at the same time.

In some possible application scenarios, the game client generally flushes (refreshes) its instruction queue from time to time (for example, by calling a gflush instruction in OpenGL to implement the flush operation) to send all graphics API instruction sequences currently initiated and buffered to the hardware driver of the GPU of the device where the game client is located. Based on this, optionally, the live broadcast provider terminal may use the flush operation on the instruction queue of the game client as a trigger signal for defining the aforementioned time interval. For example, the live broadcast provider terminal can send the currently buffered to-be-sent data packets to the server at the same time through the aforementioned independent network IO thread when detecting that the instruction queue of the game client is flushed.

Some graphics APIs that the game client generally calls during the rendering process need to use the call processing results of the previously called graphics APIs, and the calling instructions for these graphics APIs are usually synchronous calling instructions. Therefore, optionally, the live broadcast provider terminal may use the synchronous calling instruction initiated by the game client as the trigger signal for defining the aforementioned time interval. For example, the live broadcast provider terminal can send all currently buffered to-be-sent data packets to the server when the intercepted graphics API instruction sequence contains a synchronous calling instruction. In this way, the server can obtain and execute other calling instructions prior to the synchronous calling instruction before executing the synchronous calling instruction.

In addition, when any of the above two situations occur, for example, when a graphics API instruction sequence including a synchronous calling instruction is intercepted, or when it is detected that the instruction queue of the game client is flushed, the live broadcast provider terminal can send the currently buffered to-be-sent data packets to the server at the same time.

In some possible scenarios, due to the excessive overhead of synchronous calling instructions, calling instructions for some graphics API may be considered as asynchronous calling instructions, while others are graphics APIs that need to use synchronous calling instructions, for example, APIs configured to generate resource identifications (IDs).

After sending the synchronous calling instruction and its calling parameters to the corresponding hardware driver, the game client can wait for a response parameter to return before sending subsequent calling instructions, but sometimes due to network slowness or malfunction or other problems, there may be a delay in the return of the response parameter of the synchronous calling instruction.

According to the inventor's research, the network problems usually cause at least one network Round-Trip Time (RTT) in the response parameter of the synchronous calling instruction returned by the server, which will seriously affect the Frames Per Second (FPS) of the rendered game picture, thereby affecting the visual effect of the game.

On this basis, the live broadcast data processing method according to the present disclosure may further include the following steps shown in FIG. 8.

In step 208, when the intercepted graphics API instruction sequence includes a synchronous calling instruction, the live broadcast provider terminal generates a pseudo response parameter of the synchronous calling instruction and returns the pseudo response parameter to the game client.

In step 209, the live broadcast provider terminal sends the pseudo response parameter to the server.

In step 210, the server establishes and saves a correspondence between the pseudo response parameter and actual response information of the synchronous calling instruction.

Optionally, the aforementioned pseudo response parameter may be referred to as a stub. In addition, there is no limitation on the execution order of the step of the live broadcast provider terminal sending the generated pseudo response parameter to the game client and the step of sending the pseudo response parameter to the server.

Optionally, when the agent program of the live broadcast provider terminal intercepts the graphics API instruction sequence including the synchronous calling instruction, in the case where the synchronous calling instruction is not executed, designated information may be returned to the game client as a response parameter for the synchronous calling instruction. The designated information returned by the agent program is the pseudo response information, which can be a preset parameter or a random parameter generated according to a pre-configured instruction, which is not limited in the present disclosure.

When the synchronous calling instruction is sent to the server, the server can execute the response parameter generated after the synchronous calling instruction, and the response parameter is the actual response parameter.

Taking the above-mentioned resource ID generating API as an example, after the live broadcast provider terminal sends to the server a graphics API instruction sequence including a calling instruction int of the resource ID generating API, the agent program can immediately generate a first resource ID and return the first resource ID to the game client, and send the first resource ID to the server. The graphics API instruction sequence including the calling instruction int of the resource ID generating API can be sent to the server according to the flow shown in FIG. 7, and after the calling instruction int is executed, a second resource ID will be generated. The server establishes a correspondence between the first resource ID and the second resource ID. In the subsequent process, when the server receives a calling instruction that needs to use the first resource ID, the server will search, according to the established correspondence, for the first resource ID for use.

Exemplarily, the above-mentioned first resource ID may serve as the above-mentioned pseudo response parameter, and the above-mentioned second resource ID may serve as the above-mentioned actual response parameter.

In this way, the waiting time required for the synchronous calling instruction can be reduced, the time required for rendering can be reduced, the FPS of the game picture can be improved, and thus the display effect of the game can be improved.

Optionally, the traffic sent from the game client to the server is relatively large, which usually takes a long time. In order to reduce the size of traffic transmitted through the network, the live broadcast provider terminal may compress and encode the to-be-sent data packets and then send the compressed and encoded data packets to the server through independent network IO threads. The compressing and encoding method may be, but is not limited to, intra-frame compression, inter-frame compression, and the like.

Optionally, in order to reduce the size of the traffic transmitted through the network, some calling parameters with small changes or static calling parameters, such as texture parameters, material parameter shaders, or the like, may be buffered in the server in advance. Certainly, these parameters can also be sent by the game client to the server in real time via the network, which is not limited in the present disclosure.

Optionally, the game client may include multiple game threads. The aforementioned graphics API instruction sequence may carry a calling order of different calling instructions initiated by the same game thread. Therefore, the server can ensure the execution order of the various calling instructions initiated by the same game thread according to the calling order. However, when there is a limitation on the execution order among different game threads, since the intercepted graphics API instruction sequence does not include timing sequence information of different game threads, the server cannot ensure the correct execution order of the calling instructions of different game threads.

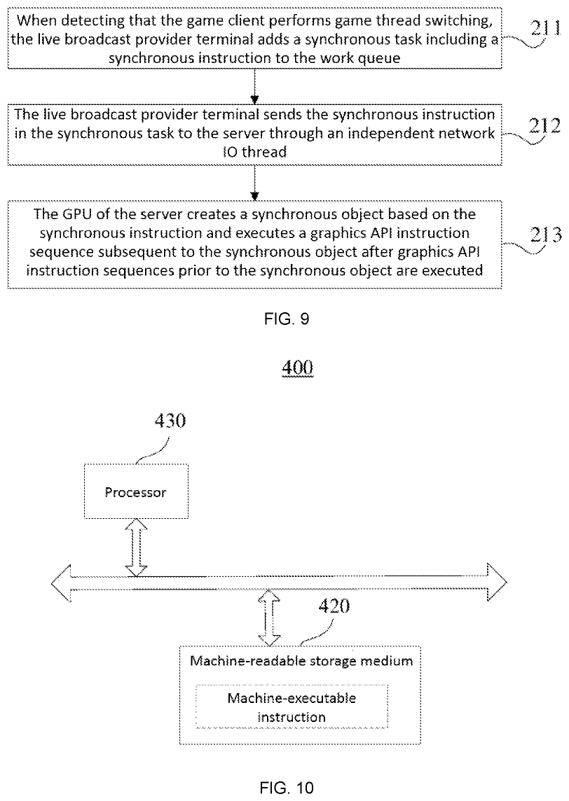

In order to solve the above-mentioned problem, as shown in FIG. 9, the above-mentioned live broadcast data processing method may further include the following steps.

In step 211, when detecting that the game client performs game thread switching, the live broadcast provider terminal adds a synchronous task including a synchronous instruction to the work queue.

In step 212, the live broadcast provider terminal sends the synchronous instruction in the synchronous task to the server through an independent network IO thread.

In step 213, the GPU of the server creates a synchronous object based on the synchronous instruction and executes a graphics API instruction sequence subsequent to the synchronous object after graphics API instruction sequences prior to the synchronous object are executed.

Exemplarily, for two game threads Thread1 and Thread2 subjected to an execution order limitation, assuming that the calling instruction in Thread1 needs to be executed prior to Thread2, the game client can run Thread1 first, and Thread1 will initiate a corresponding graphics API instruction sequence {X, Y}; then, the game client switches to Thread2, and Thread2 initiates a corresponding graphics API instruction sequence {Z, M}.

On this basis, when detecting that the game thread of the game client is switched from Thread1 to Thread2, the live broadcast provider terminal can immediately generate a synchronous instruction configured to create a synchronous object, and encapsulate the synchronous instruction into a task (i.e., a synchronous task) and add the task to the work queue. The generated synchronous task will be added to the work queue and between a task including the graphics API instruction sequence {X, Y} and a task including the graphics API instruction sequence {Z, M}.

In this way, after starting to execute a calling instruction X and a calling instruction Y, the GPU of the server will immediately execute the synchronous instruction to create a synchronous object.

Here, the synchronous instruction may be, for example, an eglCreateSyncKHR instruction provided by OpenGL, and a synchronous object created by the synchronous instruction is equivalent to a fence set between the calling instruction initiated by Thread1 and the calling instruction initiated by Thread2. After setting the synchronous object, the GPU can block the calling instruction of Thread2 through a waiting interface (for example, eglClientWaitSyncKHR). When the GPU executes to the synchronous object, it indicates all the calling instructions before the fence (for example, the above X and Y) are executed, and thus a signal will be sent to the waiting interface; then, the waiting interface stops blocking, and the calling instruction (for example, the above Z and M) initiated by the thread Thread1 can be executed by the GPU.

Through the steps shown in FIG. 9, it can be ensured that the execution order of the server for the calling instructions of different game threads is consistent with that at the game client.

Optionally, according to the foregoing process, the server may perform rendering to obtain a game picture corresponding to the control instruction. Optionally, the server may capture the rendered game picture, encode the captured game picture into a video stream and send the video stream to the game client through a stub program. The game client receives the video stream through the agent program, and decodes and displays the video stream, so as to achieve the remote rendering for the picture of the game client.

Through the above solution in the present disclosure, the GPU resources and CPU resources of the server can be decoupled, thereby reducing the hardware requirements for the CPU resources of the server.

In addition, some implementation strategies generally run a complete game client on the server. As a huge whole, the server has very high requirements for hardware and also has massive software programs, and thus subsequent maintenance and upgrades are difficult. For this reason, according to the above-mentioned solution in the present disclosure, the processing logic of the game client is partially deployed on the user-side device such as the live broadcast provider terminal, which reduces the complexity of the program on the server side and makes subsequent upgrades, compatibility, and environmental isolation of programs in the server easier, thereby reducing the development cost of the programs in the server.

To make those skilled in the art to better understand the above solution, an exemplary implementation is given below for illustration in conjunction with the game client shown in FIG. 6.

It is assumed that the game client includes the aforementioned game threads Thread1 and Thread2. Here, the game client first runs the game thread Thread1 Based on the control instruction a1 input by the user, the game thread Thread1 initiates the above-mentioned graphics API instruction sequence {X, Y} which includes the calling instructions X and Y arranged in sequence. Then, the game client switches from the game thread Thread1 to the game thread Thread2. Based on the control instruction a2 input by the user, the game thread Thread2 initiates the above graphics API instruction sequence {Z, M} which includes the call instructions Z and M arranged in sequence. Based on a control instruction a3 input by the user, the game thread Thread2 initiates a graphics API instruction sequence {V, W} which includes calling instructions V and W arranged in sequence, and the calling instruction V is a synchronous calling instruction.

Then, the remote rendering method according to the embodiment may include the following processes.

First, the agent program set in the game client intercepts the graphics API instruction sequence {X, Y}, encapsulates the graphics API instruction sequence into a task t1, and adds the task t1 to the work queue.

Second, when detecting that the game client switches from the game thread Thread1 to the game thread Thread2, the agent program generates a synchronous instruction K configured to create a synchronous object, encapsulates the synchronous instruction K into a synchronous task t2, and adds the synchronous task t2 to the work queue. It can be understood that the synchronous task t2 is subsequent to the task t1.

Third, the agent program intercepts the graphics API instruction sequence {Z, M}, encapsulates the graphics API instruction sequence into a task t3, and adds the task t3 to the work queue. Currently, tasks t1, t2, and t3 are arranged in sequence in the work queue.

Fourth, the tasks in the work queue are executed sequentially through independent network IO threads. First, the graphics API instruction sequence in the task t1 is packaged into a to-be-sent data packet data1 and buffered, and then the synchronous instruction K encapsulated in the task t2 is packaged into a to-be-sent data packet data2 and buffered, and then the graphics API instruction sequence encapsulated in the task t3 is packaged into a to-be-sent data packet data3 and buffered.

It should be noted that the operation of the agent program intercepting a graphics API instruction sequence, encapsulating the graphics API instruction sequence into a task and adding the task to the work queue is executed in parallel with the operation of executing the tasks in the work queue through the independent network IO threads.

Fifth, the agent program intercepts a graphics API instruction sequence {V, W} and detects that the graphics API instruction sequence includes a synchronous calling instruction V, so the currently buffered to-be-sent data packets data1, data2, and data3 were sent out. The sending order of the to-be-sent data packets data1, data2, and data3 is consistent with the interception order of the graphics API instruction sequences included in the data packets.

Sixth, the agent program encapsulates the graphics API instruction sequence {V, W} into a task t4 and adds the task t4 to the work queue. The agent program will execute the task t4 according to the above-mentioned step four, and send to the server the to-be-sent data packet data4 corresponding to task t4 when the synchronous calling instruction is intercepted next time or the game client flushes the instruction queue.

Seventh, the server receives the to-be-sent data packets data1, data2, data3, and data4 in sequence through the stub program 220, and parses the graphics API instruction sequence {X, Y} from data1, the synchronous instruction K from data 2, the graphics API instruction sequence {Z, M} from data3, and the graphics API instruction sequence {V, W} from data4.

Eighth, according to the order of receiving the data packets where the parsed instructions or instruction sequences are located, the GPU of the server sequentially starts to execute the above instructions X, Y, and K. When the execution process goes to the instruction K, and because the instruction K is a synchronous instruction, the GPU will create a synchronous object which can play a blocking role, and only after all the instructions prior to the synchronous object are executed, the GPU starts to execute the subsequent instructions Z, M, V, and W.

Ninth, by executing the above instructions to perform rendering continuously, the corresponding game picture can be obtained. The server captures the rendered game picture through a video encoding program, encodes the captured game picture into a video stream, and returns the video stream to the game client for display through the live broadcast provider terminal where the game client is located.

In addition, based on the same inventive concept as the above-mentioned live broadcast data processing method of the present disclosure, a present disclosure further provides a live broadcast system as shown in FIG. 1. The live broadcast system includes a live broadcast provider terminal and a server. The live broadcast system can be run to implement the live broadcast data processing method of the present disclosure.

In addition, referring to FIG. 10, it shows a schematic structural block diagram of an electronic device according to the present disclosure. In various embodiments, the electronic device may serve as the server shown in FIG. 1 or the live broadcast provider terminal shown in FIG. 1, and the electronic device may include a machine-readable storage medium and a processor.

In the above, the processor may be a general-purpose Central Processing Unit (CPU), a microprocessor, an Application-Specific Integrated Circuit (ASIC), or one or more integrated circuits configured to control the program execution of the live broadcast data processing methods according to the foregoing method embodiments.

The machine-readable storage medium may be an ROM or other types of static storage devices that can store static information and instructions, an RAM or other types of dynamic storage devices that can store information and instructions, or it may also be, but not limited to, an Electrically Erasable Programmabler-Only MEMory (EEPROM), a Compactdisc Read-Only MEMory (CD-ROM) or other light disk memories, optical disc memories (including compact discs, laser discs, optical discs, digital universal discs, Blu-ray discs, and the like), magnetic disc storage media or other magnetic storage devices, or any other media that can be configured to carry or store desired program codes in the form of instruction or data structures and that can be accessed by a computer. The machine-readable storage medium may exist independently and is connected to the processor through a communication bus. The machine-readable storage medium may also be integrated with the processor. Here, the machine-readable storage medium is configured to store machine-executable instructions for executing the solution of the present disclosure. The processor is configured to execute the machine-executable instructions stored in the machine-readable storage medium to implement the steps executed by the server in the foregoing method embodiment or the steps executed by the live broadcast provider terminal in the foregoing method embodiment.

Since the electronic device according to the embodiment of the present disclosure can be configured to execute the steps executed by the server in the foregoing method embodiment, or can be configured to execute the steps executed by the live broadcast provider terminal in the foregoing method embodiment, the exemplary steps executed by the electronic device and the technical effects that can be obtained can refer to the foregoing method embodiments and will not be detailed here again.

In addition, the present disclosure further provides a readable storage medium including computer-executable instructions. When executed, the computer-executable instructions can be configured to execute the steps executed by the server in the foregoing method embodiment or execute the steps executed by the live broadcast provider terminal in the foregoing method embodiment.

Certainly, in the storage medium including computer-executable instructions according to the embodiment of the present disclosure, the computer-executable instructions are not limited to executing the operations of the methods described above, and can also execute related operations in the live broadcast data processing method according to any embodiment of the present disclosure.

The embodiments of the present disclosure are described with reference to the flowcharts and/or the block diagrams of the methods, devices, and computer program products according to the embodiments of the present disclosure. It should be understood that each process and/or block in the flowcharts and/or block diagrams, as well as combinations of the processes and/or blocks in the flowcharts and/or the block diagrams, may be implemented by computer program instructions. These computer program instructions may be provided to a processor of a general-purpose computer, a special-purpose computer, an embedded processor, or other programmable data processing devices to produce a machine such that instructions are executed by the processor of the general-purpose computer or other programmable data processing devices to produce an apparatus configured to implement the functions specified in one or more processes in the flowcharts and/or one or more blocks in the block diagrams.

Although the present disclosure is described here in conjunction with various embodiments, in the process of implementing the present disclosure claimed, those skilled in the art can understand and implement other changes of the embodiments of the present disclosure by viewing the drawings, the content disclosed and the appended claims. In the claims, the word “including” does not exclude other components or steps, and the word “a” or “an” does not exclude a plurality. A single processor or other unit can implement several functions listed in the claims. Certain measures are described in mutually different dependent claims, but it does not mean that these measures cannot be combined to produce good effects.

The above are only various implementations of the present disclosure and the protection scope of the present disclosure is not limited thereto. Any changes or substitutions reached easily by those skilled in the art within the technical scope disclosed in the present disclosure shall fall within the protection scope of the present disclosure. Therefore, the protection scope of the present disclosure should be defined by the protection scope of the appended claims.

### INDUSTRIAL APPLICABILITY

Since the process of processing the graphic interaction data is configured at the server side of the live broadcast system, the data processing volume of the live broadcast provider terminal can be reduced, thereby reducing the hardware overhead of the live broadcast provider terminal and improving the live broadcast effect.

In some possible scenarios, by sending the game resources of the live game to the server, the server can adjust the game resources to generate corresponding live broadcast cache data, and then send the live broadcast cache data to the live broadcast receiver terminal for playback. In this way, the game resources of the live game can be individually adjusted on the server according to requirements.

In addition, in some possible scenarios, the drawing instructions configured to render the picture and the drawing parameters corresponding to the drawing instructions are stored into a lock-free queue; when a preset information sending condition is met, the drawing instructions and the drawing parameters that are stored in the lock-free queue are sent to the server, and the server performs the picture rendering according to the drawing instructions and the drawing parameters; finally the rendered picture is received from the server to be displayed. In this way, the number of calls to the IO thread to send the data and the number of context switches can be reduced, and thus the time consumption of the terminal device for sending the data and the delay of the entire cloud rendering process can be reduced.

Moreover, in some possible scenarios, a graphics API instruction sequence initiated by the game client based on a control instruction input by a user is intercepted, the intercepted graphics API instructions are sent to the server in an interception order, and then the GPU of the server executes the graphics API instruction sequence to obtain the rendered game picture. In this way, the logic that can be processed by the CPU is separated from the server and put on the live broadcast provider terminal on the user side to run, which reduces the hardware cost of the server and makes subsequent program upgrade, compatibility, and environmental isolation easier, thereby reducing the development cost.

1. (canceled)

2. (canceled)

3. (canceled)

4. (canceled)

5. A live broadcast data processing method, applicable to a live broadcast provider terminal, the method comprising following steps:
calling, after a live game is run, interface parameters of an application programming interface corresponding to game resources in the live game to obtain the game resources of the live game;
sending the game resources to a server so that, after receiving the game resources, the server adjusts the game resources according to a setting rule, generates corresponding live broadcast cache data according to adjusted game resources and then sends the live broadcast cache data to a live broadcast receiver terminal for playback.

6. The live broadcast data processing method according to claim 5, wherein the step of calling, after a live game is run, interface parameters of an application programming interface corresponding to game resources in the live game to obtain the game resources of the live game comprises:
running a preset dynamic link library file in a running process of the live game after the live game is run, wherein the preset dynamic link library file comprises a running program configured to intercept the interface parameters of the application programming interface of the live game, and the application programming interface comprises a graphics application programming interface and/or an audio application programming interface;
obtaining the interface parameters of the application programming interface of the live game through the preset dynamic link library file and obtaining the game resources of the live game according to the interface parameters, wherein the game resources comprises game graphics resources and game audio resources.

7. (canceled)

8. (canceled)

9. (canceled)

10. (canceled)

11. (canceled)

12. (canceled)

13. A remote rendering method, applicable to an electronic device installed with a game client, the electronic device being in communication connection with a game server, the method comprising following steps:
intercepting, by the game client, a graphics API instruction sequence initiated based on a control instruction input by a user, wherein the graphics API instruction sequence comprises calling instructions, calling parameters and a calling order at the game client to graphics APIs;
sending an intercepted graphics API instruction sequence to the game server according to an interception order so that a GPU of the game server executes the graphics API instruction sequence to obtain a rendered game picture.

14. The remote rendering method according to claim 13, wherein the step of intercepting, by the game client, a graphics API instruction sequence initiated based on a control instruction input by a user comprises following steps:
encapsulating each intercepted graphics API instruction sequence into a task, and adding encapsulated tasks to a work queue according to the interception order;
executing the tasks in the work queue sequentially through independent network IO thread and sending the graphics API instruction sequence in each task to the game server.

15. The remote rendering method according to claim 14, wherein the step of executing the tasks in the work queue sequentially through independent network IO thread and sending the graphics API instruction sequence in each task to the game server comprises:
processing the graphics API instruction sequence in each task in sequence into a to-be-sent data packet and buffering the to-be-sent data packet;
sending currently buffered to-be-sent data packets to the game server at the same time when a graphics API instruction sequence comprising a synchronous calling instruction is intercepted, or when it is detected that an instruction queue of the game client is flushed.

16. The remote rendering method according to claim 14, the method further comprising:
adding a synchronous task comprising a synchronous instruction to the work queue when detecting that the game client performs game thread switching;
sending the synchronous instruction in the synchronous task to the game server through the independent network IO thread, so that a GPU of the game server creates a synchronous object based on the synchronous instruction and executes a graphics API instruction sequence subsequent to the synchronous object after graphics API instruction sequences prior to the synchronous object are executed.

17. The remote rendering method according to claim 13, the method further comprising:
generating pseudo response information of a synchronous calling instruction and returning the pseudo response information to the game client when the intercepted graphics API instruction sequence comprises the synchronous calling instruction;
sending the pseudo response information to the game server so that the game server establishes and saves a correspondence between the pseudo response information and actual response information of the synchronous calling instruction.

18. A live broadcast data processing method, applicable to a live broadcast system, the live broadcast system comprising a live broadcast provider terminal and a server that establish communication with each other, the method comprising following steps:
sending to the server, by the live broadcast provider terminal, a data execution instruction and graphic interaction data corresponding to the data execution instruction;
processing, in response to the data execution instruction, by the server, the graphic interaction data and sending out an obtained graphic interaction picture,
wherein the live broadcast system further comprises a live broadcast receiver terminal communicating with the server;
the step of sending to the server, by the live broadcast provider terminal, a data execution instruction and graphic interaction data corresponding to the data execution instruction comprises a following step:
calling, after a live game is run, by the live broadcast provider terminal, interface parameters of an application programming interface corresponding to game resources in the live game to obtain the game resources of the live game, and sending the data execution instruction and the game resources to the server, wherein the graphic interaction data are the game resources; and
the step of processing, in response to the data execution instruction, by the server, the graphic interaction data and sending out an obtained graphic interaction picture comprises a following step:
adjusting, in response to the data execution instruction, by the server, the game resources according to a setting rule and generating corresponding live broadcast cache data according to adjusted game resources, wherein the graphic interaction picture is the live broadcast cache data;
sending, by the server, the live broadcast cache data to the live broadcast receiver terminal for playback.

19. (canceled)

20. The live broadcast data processing method according to claim 18, wherein the setting rule comprises preset viewing angle customization information; and the step of adjusting, by the server, the game resources according to a setting rule comprises:
calling, by the server, an interface instruction sequence and interface resources of a graphics application programming interface corresponding to the live game and adjusting a camera viewing angle in the game resources to a preset viewing angle in the preset viewing angle customization information;
adjusting, by the server, the game resources based on the preset viewing angle to generate the adjusted game resources.

21. (canceled)

22. The live broadcast data processing method according to claim 18, wherein the setting rule further comprises game texture replacement information, and the game texture replacement information comprises identification information of at least one to-be-replaced first game texture image and a second game texture image configured to replace each first game texture image; and
the step of adjusting, by the server, the game resources according to a setting rule comprises:
calling, by the server, an interface instruction sequence and interface resources of a graphics application programming interface corresponding to the live game, and obtaining each to-be-replaced first game texture image from the game resources according to identification information of each first game texture image;
replacing, by the server, each to-be-replaced first game texture image with a corresponding second game texture image to generate the adjusted game resources.

23. (canceled)

24. (canceled)

25. The live broadcast data processing method according to claim 22, the method further comprising a following step:
configuring the setting rule by the server according to operating service information of a live broadcast platform,
wherein the step of configuring the setting rule by the server according to operating service information of a live broadcast platform comprises following steps:
obtaining, by the server, an advertising content and an advertising rule of each advertiser from the operating service information;
determining, for each advertiser, by the server, identification information of a to-be-replaced first game texture image of the advertiser in the live game according to the advertising rule of the advertiser;
generating, by the server, according to the advertising content of the advertiser, a second game texture image configured to replace each first game texture image,
wherein the step of determining, by the server, identification information of a to-be-replaced first game texture image of the advertiser in the live game according to the advertising rule of the advertiser comprises:
obtaining, by the server, feature information of each game texture image in the live game;
determining, by the server according to the feature information of each game texture image and the advertising rule of the advertiser, the identification information of the first game texture image, among various game texture images, that can display the advertising content of the advertiser; and
the step of generating, by the server, according to the advertising content of the advertiser, a second game texture image configured to replace each first game texture image comprises:
determine, by the server, advertising content corresponding to each first game texture image according to the identification information and the feature information of each first game texture image;
adding, by the server, determined advertising contents to corresponding first game texture images, respectively, to generate corresponding second game texture images.

26. The live broadcast data processing method according to claim 18, wherein the setting rule comprises game audio customization information, and the game audio customization information comprises identification information of at least one to-be-replaced first game audio and a second game audio configured to replace each first game audio; and
the step of adjusting, by the server, the game resources according to a setting rule comprises:
calling, by the server, an interface instruction sequence and interface resources of an audio application programming interface corresponding to the live game, and obtaining each to-be-replaced first game audio from the game resources according to identification information of each first game audio;
replacing, by the server, each to-be-replaced first game audio with a corresponding second game audio to generate the adjusted game resources.

27. The live broadcast data processing method according to claim 18, the method further comprising:
receiving, by the server, game interception information sent by the live broadcast receiver terminal in response to a user operation, wherein the game interception information comprises at least one of game image interception information and game element interception information;
obtaining, by the server, according to the game interception information, a corresponding target game image from the live broadcast cache data; and/or obtaining a corresponding target game element texture image from the game resources;
sending, by the server, the target game image and/or the target game element texture image to the live broadcast receiver terminal.

28. The live broadcast data processing method according to claim 18, wherein the step of calling, after a live game is run, by the live broadcast provider terminal, interface parameters of an application programming interface corresponding to game resources in the live game to obtain the game resources of the live game comprises:
running, by the live broadcast provider terminal, a preset dynamic link library file in a running process of the live game after the live game is run, wherein the preset dynamic link library file comprises a running program configured to intercept the interface parameters of the application programming interface of the live game, the application programming interface comprises a graphics application programming interface and/or an audio application programming interface;
obtaining, by the live broadcast provider terminal, the interface parameters of the application programming interface of the live game through the preset dynamic link library file and obtaining the game resources of the live game according to the interface parameters, wherein the game resources comprise game graphics resources and game audio resources.

29. The live broadcast data processing method according to claim 18, wherein the step of sending to the server, by the live broadcast provider terminal, a data execution instruction and graphic interaction data corresponding to the data execution instruction comprises following steps:
storing in a lock-free queue, by the live broadcast provider terminal, drawing instructions configured to render a picture and drawing parameters corresponding to the drawing instructions, wherein multiple drawing instructions are required to render one picture, the data execution instruction is the drawing instructions, the graphic interaction data are the drawing parameters;
sending by the live broadcast provider terminal to the server the drawing instructions and the drawing parameters stored in the lock-free queue when detecting that a preset information sending condition is met;
the step of processing, in response to the data execution instruction, by the server, the graphic interaction data and sending out an obtained graphic interaction picture comprises following steps:
performing picture rendering by the server according to the drawing instructions and the drawing parameters after receiving the drawing instructions and the drawing parameters;
encoding, by the server, a rendered picture and sending an encoded picture to the live broadcast provider terminal after finishing the picture rendering, wherein the graphic interaction picture is the rendered picture; and
the method further comprises a following step:
receiving, by the live broadcast provider terminal, the encoded picture, decoding a received picture and displaying a decoded picture.

30. (canceled)

31. (canceled)

32. (canceled)

33. (canceled)

34. (canceled)

35. (canceled)

36. (canceled)

37. The live broadcast data processing method according to claim 18, wherein the live broadcast provider terminal is installed with a game client;
the step of sending to the server, by the live broadcast provider terminal, a data execution instruction and graphic interaction data corresponding to the data execution instruction comprises following steps:
intercepting, by the live broadcast provider terminal, a graphics API instruction sequence initiated by the game client based on a control instruction input by a user, wherein the graphics API instruction sequence comprises calling instructions, calling parameters and a calling order at the game client to graphics APIs, the graphic interaction data are the graphics API instruction sequence;
sending to the server, by the live broadcast provider terminal, the data execution instruction and an intercepted graphics API instruction sequence according to an interception order; and
the step of processing, in response to the data execution instruction, by the server, the graphic interaction data and sending out an obtained graphic interaction picture comprises following steps:
enabling a GPU, by the server in response to the data execution instruction, to execute the graphics API instruction sequence to obtain a rendered game picture and sending out the rendered game picture, wherein the graphic interaction picture is the rendered game picture.

38. The live broadcast data processing method according to claim 37, wherein the step of intercepting, by the live broadcast provider terminal, a graphics API instruction sequence initiated by the game client based on a control instruction input by a user comprises following steps:
encapsulating, by the live broadcast provider terminal, each intercepted graphics API instruction sequence into a task, and adding encapsulated tasks to a work queue according to the interception order;
executing, by the live broadcast provider terminal, the tasks in the work queue sequentially through independent network IO thread and sending a graphics API instruction sequence in each task to the server.

39. The live broadcast data processing method according to claim 38, wherein the step of executing, by the live broadcast provider terminal, the tasks in the work queue sequentially through independent network IO thread and sending a graphics API instruction sequence in each task to the server comprises following steps:
processing, by the live broadcast provider terminal, the graphics API instruction sequence in each task in sequence into a to-be-sent data packet and buffering the to-be-sent data packet;
sending, by the live broadcast provider terminal, currently buffered to-be-sent data packets to the server at the same time when a graphics API instruction sequence comprising a synchronous calling instruction is intercepted, or when it is detected that an instruction queue of the game client is flushed.

40. (canceled)

41. The live broadcast data processing method according to claim 38, the method further comprising:
adding, by the live broadcast provider terminal, a synchronous task comprising a synchronous instruction to the work queue when detecting that the game client performs game thread switching;
sending, by the live broadcast provider terminal, the synchronous instruction in the synchronous task to the server through an independent network IO thread;
creating, by a GPU of the server, a synchronous object based on the synchronous instruction and executing a graphics API instruction sequence subsequent to the synchronous object after graphics API instruction sequences prior to the synchronous object are executed.

42. The live broadcast data processing method according to claim 37, the method further comprising:
generating, by the live broadcast provider terminal, pseudo response information of a synchronous calling instruction and returning the pseudo response information to the game client when an intercepted graphics API instruction sequence comprises the synchronous calling instruction;
sending, by the live broadcast provider terminal, the pseudo response information to the server;
establishing and saving, by the server, a correspondence between the pseudo response information and actual response information of the synchronous calling instruction.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
